(19) United States
(12) Patent Application Publication
(10) Pub. No.: US 2026/0280992 A1
(43) Pub. Date: Sep. 17, 2026

(54) COLLECTIVE COMMUNICATION PROCESSING METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventors: Junhong YE, Shenzhen (CN); Lei HE, Shenzhen (CN); Feng JIN, Shenzhen (CN)

(21) Appl. No.: 19/670,430

(22) Filed: May 7, 2026

Related U.S. Application Data
(63) Continuation of application No. PCT/CN2025/078022, filed on Feb. 19, 2025.

(30) Foreign Application Priority Data
Feb. 27, 2024 (CN) 202410218312.3

(51) Int. Cl. H04L 41/12; H04L 41/0893

(52) U.S. Cl. CPC H04L 41/12; H04L 41/0893

(57) ABSTRACT

A collective communication processing method includes obtaining a node orchestration request for a target collective operation in collective communication, the node orchestration request carrying an original node list, and the original node list comprising server nodes selected to perform the target collective operation; obtaining topology information of the server nodes, the topology information describing switching nodes connected to the server nodes at various levels in a node communication network, and the server nodes communicating with each other based on the switching nodes connected at the levels in the node communication network; performing an orchestration update on a sequence of the server nodes based on the topology information and levels in the node communication network, to obtain an orchestration node list; and performing collective communication for the target collective operation using the server nodes based on the sequence of the server nodes in the orchestration node list.

### RELATED APPLICATIONS

This application is continuation of PCT Application No. PCT/CN2025/078022, filed on Feb. 19, 2025, which in turn claims priority to Chinese Patent Application No. 2024102183123, filed on Feb. 27, 2024, and entitled “COLLECTIVE COMMUNICATION PROCESSING METHOD AND APPARATUS, COMPUTER DEVICE, AND STORAGE MEDIUM”, which are both incorporated herein by reference in their entirety.

### FIELD OF THE TECHNOLOGY

This application relates to the field of computer technologies, and in particular, to a collective communication processing method and apparatus, a computer device, a storage medium, and a computer program product.

### BACKGROUND OF THE DISCLOSURE

With development of computer technologies, a distributed system including a plurality of independent nodes can greatly improve computation efficiency, and save overall computation time. For example, a large-scale artificial intelligence model may be efficiently trained based on a high-performance computing cluster including distributed servers.

In the distributed system, through various collective operations in collective communication, nodes can efficiently exchange data, synchronize statuses, and coordinate behavior, thereby implementing cooperative working and global computing. However, currently, when nodes in a distributed setting perform collective communication, collective operations between nodes are inefficient.

### SUMMARY

According to embodiments provided in this application, a collective communication processing method and apparatus, a computer device, a computer-readable storage medium, and a computer program product are provided.

One aspect of this application provides a collective communication processing method, performed by a second server, and including obtaining a node orchestration request for a target collective operation in collective communication, the node orchestration request carrying an original node list, and the original node list comprising server nodes selected to perform the target collective operation; obtaining topology information of the server nodes, the topology information describing switching nodes connected to the server nodes at various levels in a node communication network, and the server nodes communicating with each other based on the switching nodes connected at the levels in the node communication network; performing an orchestration update on a sequence of the server nodes based on the topology information and levels in the node communication network, to obtain an orchestration node list; and performing collective communication for the target collective operation using the server nodes based on the sequence of the server nodes in the orchestration node list.

Another aspect of this application further provides a computer device, including a memory and a processor, the memory having computer-readable instructions stored therein, and the operations of the foregoing collective communication processing method being implemented when the processor executes the computer-readable instructions.

Another aspect of this application further provides a non-transitory computer-readable storage medium, having computer-readable instructions stored therein, the operations of the foregoing collective communication processing method being implemented when the computer-readable instructions are executed by a processor.

Another aspect of this application provides a collective communication processing method, performed by a first server, and including obtaining a node orchestration request for a target collective operation in collective communication, the node orchestration request carrying an original node list, and the original node list comprising server nodes selected to perform the target collective operation obtaining topology information of the server nodes, the topology information describing switching nodes connected to the server nodes at various levels in a node communication network, and the server nodes communicating with each other based on the switching nodes connected at the levels in the node communication network; performing an orchestration update on a sequence of the server nodes based on the topology information and levels in the node communication network, to obtain an orchestration node list; and performing collective communication for the target collective operation using the server nodes based on the sequence of the server nodes in the orchestration node list.

Details of one or more embodiments of this application are provided in the accompanying drawings and descriptions below. Other features and advantages of this application become clear with reference to the specification, the accompanying drawings, and the claims.

### BRIEF DESCRIPTION OF THE DRAWINGS

To describe the technical solutions in embodiments of this application or the conventional technology more clearly, the following briefly describes the accompanying drawings required for describing embodiments or the conventional technology. Apparently, the accompanying drawings in the following descriptions show merely embodiments of this application, and a person of ordinary skill in the art may still derive other accompanying drawings from the disclosed accompanying drawings without creative efforts.

FIG. 1 is a diagram of an application environment of a collective communication processing method according to some embodiments.

FIG. 2 is a schematic flowchart of a collective communication processing method according to some embodiments.

FIG. 3A is a diagram of data transmission performed by server nodes based on switching nodes according to some embodiments.

FIG. 3B is a diagram of a change due to an orchestration update performed on an original node list according to some embodiments.

FIG. 4 is a schematic flowchart of orchestration update processing according to some embodiments.

FIG. 5 is a schematic flowchart of a collective communication processing method according to some embodiments.

FIG. 6 is a topology diagram of a data center network according to some embodiments.

FIG. 7 is a topology diagram of a data center network according to some embodiments.

FIG. 8 is a diagram of a logical traffic ring according to the embodiments shown in FIG. 7.

FIG. 9 is a diagram of network traffic according to the embodiments shown in FIG. 7.

FIG. 10 is a diagram of a logical traffic ring when optimization is not performed according to the embodiments shown in FIG. 7.

FIG. 11 is a diagram of network traffic when optimization is not performed according to the embodiments shown in FIG. 7.

FIG. 12 is a topology diagram of a multi-tenant data center network according to some embodiments.

FIG. 13 is a diagram of a logical traffic ring according to the embodiments shown in FIG. 12.

FIG. 14 is a diagram of network traffic according to the embodiments shown in FIG. 12.

FIG. 15 is a diagram of a logical traffic ring when optimization is not performed according to the embodiments shown in FIG. 12.

FIG. 16 is a diagram of network traffic when optimization is not performed according to the embodiments shown in FIG. 12.

FIG. 17 is a diagram of a relationship between an uplink flow number of a switch at an access layer and a congestion probability according to some embodiments.

FIG. 18 is a system architecture diagram of a collective communication processing method according to some embodiments.

FIG. 19 is a schematic flowchart of a collective communication processing method according to some embodiments.

FIG. 20 is a diagram of topological clustering according to some embodiments.

FIG. 21 is a diagram of a topological clustering result according to some embodiments.

FIG. 22 is a diagram of a logical traffic ring according to the embodiments shown in FIG. 21.

FIG. 23 is a diagram of comparison between net throughput depending on whether optimization is performed in collective communication processing according to some embodiments.

FIG. 24 is a structural block diagram of a collective communication processing apparatus according to some embodiments.

FIG. 25 is a structural block diagram of a collective communication processing apparatus according to some embodiments.

FIG. 26 is a diagram of an internal structure of a computer device according to some embodiments.

### DESCRIPTION OF EMBODIMENTS

The technical solutions in embodiments of this application are clearly and completely described below with reference to the accompanying drawings in embodiments of this application. Apparently, the described embodiments are merely some rather than all of embodiments of this application. All other embodiments obtained by a person of ordinary skill in the art based on embodiments of this application without creative efforts fall within the protection scope of this application.

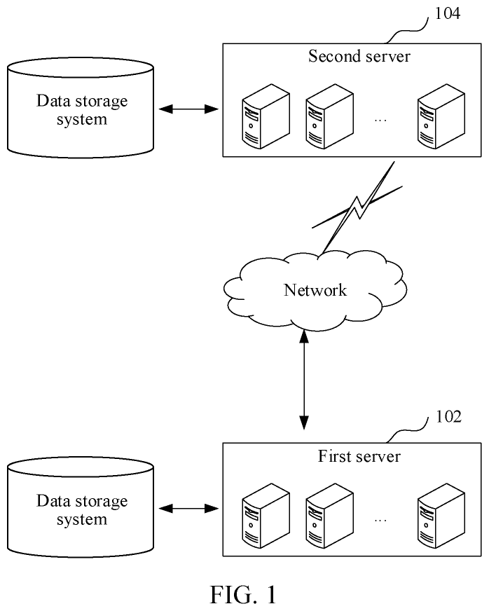

A collective communication processing method provided in embodiments of this application may be applied to an application environment shown in FIG. 1. A computer device in the application environment includes servers such as a first server 102 and a second server 104, and the first server 102 communicates with the second server 104 through a network. A data storage system may store data that a server connected to the data storage system needs to process. The data storage system may be disposed independently, may be integrated to the server connected to the data storage system, or may be deployed on cloud or another server. When triggering to perform a target collective operation in collective communication, the first server 102 may transmit a node orchestration request for the target collective operation to the second server 104. The node orchestration request carries an original node list. The original node list includes server nodes for the target collective operation. The first server 102 is determined in the server nodes. After the second server 104 receives the node orchestration request, for the server nodes for the target collective operation in the original node list carried in the node orchestration request, the second server 104 performs an orchestration update on an sequence of the server nodes level by level based on topology information of the server nodes and levels in a node communication network, to obtain an orchestration node list. The second server 104 may return the orchestration node list to the first server 102, so that the first server 102 performs collective communication for the target collective operation by using the server nodes based on an sequence of the server nodes in the orchestration node list.

In addition, when the target collective operation in the collective communication is triggered, the first server 102 determines the original node list including the server nodes for the target collective operation. The first server 102 transmits, to the second server 104, the node orchestration request generated based on the original node list, and receives the orchestration node list that is returned by the second server 104 and that is obtained by performing the orchestration update on the sequence of the server nodes in the original node list. The first server 102 performs collective communication for the target collective operation by using the server nodes based on the sequence of the server nodes in the orchestration node list. In some embodiments, the collective communication processing method may alternatively be independently implemented by the first server 102. To be specific, the first server 102 directly performs orchestration update processing on the sequence of the server nodes, and performs collective communication based on the obtained orchestration node list.

A server may be an independent physical server, may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a CDN, big data, and an artificial intelligence platform. In addition, at least one of the first server 102 and the second server 104 in in the application environment may be replaced with a terminal for implementation. The terminal may be, but is not limited to, various desktop computers, notebook computers, smartphones, tablet computers, internet of things devices, and portable wearable devices. The internet of things devices may be a smart speaker, a smart television, a smart air conditioner, a smart in-vehicle device, and the like. The portable wearable devices may be a smart watch, a smart band, a head-mounted device, and the like.

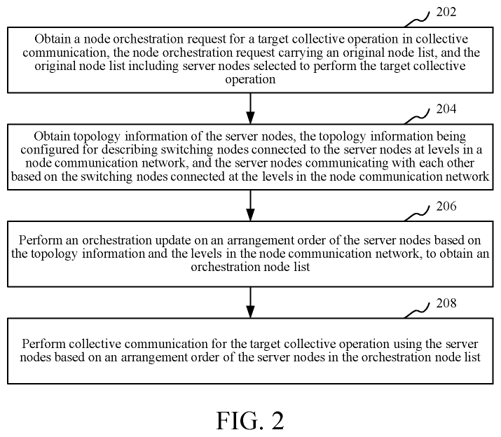

In one embodiment, as shown in FIG. 2, a collective communication processing method is provided. The method is performed by a computer device. Specifically, the method may be independently performed by the computer device like a terminal or a server, or may be jointly performed by the terminal and the server. In this embodiment, an example in which the method is applied to the second server in FIG. 1 is used for description. The method includes the following operation 202 to operation 208:

Operation 202: Obtain a node orchestration request for a target collective operation in collective communication, the node orchestration request carrying an original node list, and the original node list including server nodes selected to perform the target collective operation.

The collective communication is a global communication operation, involves participation of all processes in a process group, and can process communication, synchronization, and computation between a large number of processes. In a distributed system, the collective communication is especially key because nodes usually need to perform a large amount of communication. For example, in a distributed training process of deep learning, data such as a large number of network model weight parameters and a large number of temporary variables generated in the training process may be transmitted through the collective communication, to improve model training efficiency. Basic operations of the collective communication include transmit, receive, copy, barrier, and signal+wait. The basic operations may be combined to obtain various collective operations. The collective operations are global communication operations that are cooperatively completed by a group of processes, and allow all the processes in the process group to participate in communication and jointly operate data. The collective operations may specifically include, but are not limited to, at least one of various communication operations such as broadcast, gather, Allgather, scatter, reduce, Allreduce, Reducescatter, and All-To-All. The target collective operation is a collective operation that is currently triggered and that needs to be performed in the collective communication, for example, may be the Allreduce operation.

The node orchestration request is configured to request an orchestration update on an sequence of the server nodes for the target collective operation. The server nodes are nodes selected to implement the target collective operation. That is, the target collective operation is implemented between the selected server nodes. For example, the Allreduce operation may be performed between the selected server nodes. The node orchestration request carries the original node list, and the original node list includes the server nodes selected to perform the target collective operation.

Specifically, the second server may obtain the node orchestration request for the target collective operation in the collective communication. Specifically, the second server may receive, through a network, the node orchestration request sent by a first server. The first server may be a node in the server nodes for the target collective operation. In some embodiments, the first server may be a node in the server nodes configured to perform the target collective operation. The second server is used as a server that performs the orchestration update on the server nodes for the target collective operations. The second server may parse the node orchestration request to obtain the original node list. The original node list includes the server nodes for the target collective operation. That is, the original node list includes the server nodes selected to perform the target collective operation. During specific application, node identifiers of the server nodes may be recorded in the original node list. For example, at least one type of identification information such as node names and node numbers of the server nodes may be recorded.

Operation 204: Obtain topology information of the server nodes, the topology information being configured for describing switching nodes connected to the server nodes at various levels in a node communication network, and the server nodes communicating with each other based on the switching nodes connected at the levels in the node communication network.

The topology information describes the switching nodes connected to the server nodes at the levels in the node communication network, to perform communication at corresponding levels by using the connected switching nodes. The server nodes and the switching nodes may be in direct communication connection, or may be in indirect communication connection via switching nodes at other levels. For example, the topology information may include node identifiers of the switching nodes connected to the server nodes at the levels in the node communication network. The node communication network may include a plurality of switching nodes, configured to perform data packet forwarding between servers. The switching node may be implemented based on at least one of devices such as a terminal, a server, and a switch. The switching nodes in the node communication network may be constructed based on a multi-level structure. Each level may include at least one switching node. The server nodes communicate with each other based on the switching nodes connected at the levels. A data routing manner during communication between server nodes may be recorded in the node communication network. That is, communication between different server nodes is implemented by performing data transmission via a corresponding switching node in the node communication network.

For example, for the server nodes in the original node list, the second server may obtain the topology information of the server nodes in the node communication network. For example, the second server may query the node communication network based on the node identifiers of the server nodes, to determine the topology information of the server nodes. The node communication network is configured to support communication between the server nodes, and may include a plurality of levels. Each level may include the switching node for communication, so that communication between the server nodes is implemented by using switching nodes at the plurality of levels. The switching nodes connected to the server nodes at the levels may be recorded in the topology information. For example, the topology information may be {H0: 1, 1, 1}, which describes that a server node H0 is connected to a switching node L1 at a first level, a switching node P1 at a second level, and a switching node C1 at a third level in the node communication network. That is, the server node H0 may communicate with other server nodes by using the switching node L1 at the first level, the switching node P1 at the second level, and the switching node C1 at the third level in the node communication network. In some embodiments, a high-level switching node is configured to implement cross-node communication between server nodes to which switching nodes at a low level are downlinked. For example, communication that crosses the switching nodes at the second level and that is between a server node to which the switching node P1 at the second level is downlinked and a server node to which the switching node P2 at the second level is downlinked needs to be implemented based on a switching node at the third level, for example, the switching node C1 at the third level.

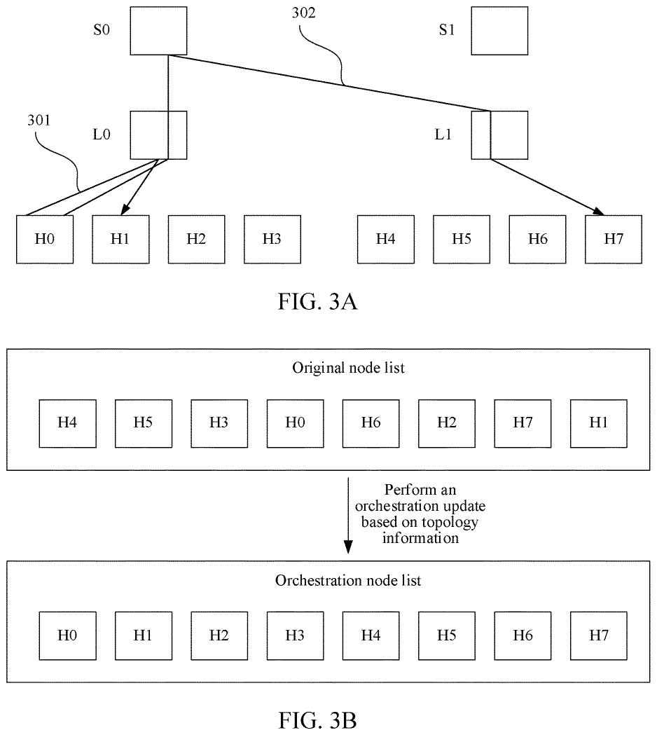

During specific implementation, as shown in FIG. 3A, the node communication network may include two levels. The first layer is an L layer, and the second layer is an S layer. The L level includes a switching node L0 and the switching node L1. The switching node L0 is downlinked to server nodes such as H0, H1, H2, and H3, and the switching node L1 is downlinked to server nodes such as H4, H5, H6, and H7. The S layer may alternatively be divided into a switching node S0 and a switching node S1, to support cross-node communication between the server nodes to which the switching node L0 and the switching node L1 are downlinked. That is, the server nodes such as H0, H1, H2, and H3 may be in direct communication connection with the switching node L0, and in indirect communication connection with the switching node S0 via the switching node L0. As shown in 301 in FIG. 3A, when the server node H0 and the server node H1 communicate with each other, both the server node H0 and the server node H1 are connected to the switching node L0 at the L level. In this case, communication between the server node H0 and the server node H1 may be directly implemented based on the switching node L0 at the L layer. That is, a data packet between the server node H0 and the server node H1 may be forwarded via the switching node L0. When the server node H0 and the server node H7 communicate with each other, as shown in 302 in FIG. 3A, the server node H0 and the server node H7 need to cross different switching nodes at the L layer, and therefore need to perform cross-node communication by using a switching node at the S layer. Specifically, a data packet between the server node H0 and the server node H7 may be forwarded via the switch node L0 at the L layer, the switch node S0 at the S layer, and the switch node L1 at the L layer. In this way, cross-node communication between server nodes connected to the different switch nodes at the L layer is implemented via the switch node at the S layer. In comparison with a manner in which the server node H0 and the server node H1 communicate with each other via the switching node L0, communication between the server node H0 and the server node H7 needs to be implemented by crossing the switching nodes L0 and L1 via the switching nodes at the S layer. In a communication process, a number of participating switching nodes is increased, and a communication delay is increased.

Operation 206: Perform the orchestration update on the sequence of the server nodes level by level based on the topology information and the levels in the node communication network, to obtain an orchestration node list.

The orchestration node list is obtained by updating the original node list, and may be specifically obtained by re-orchestrating the sequence of the server nodes. The orchestration update on the sequence of the server nodes level by level may be implemented based on a descending or ascending level dimension. For example, when the node communication network includes N levels, the second server may perform the orchestration update on the sequence of the server nodes level by level based on a level dimension from the first level to an N^{th} level, or may perform the orchestration update on the sequence of the server nodes level by level based on a level dimension from an N^{th} level to the first level.

In some embodiments, the second server may perform the orchestration update on the sequence of the server nodes. Specifically, the second server performs the orchestration update level by level based on the topology information of the server nodes and the levels in the node communication network, to re-orchestrate the sequence of the server nodes, thereby obtaining the orchestration node list. An sequence of the server nodes in the orchestration node list may be determined based on a level dimension for performing the orchestration update level by level. As shown in FIG. 3B, the original node list carried in the node orchestration request includes a total of eight server nodes: H0, H1, H2, H3, H4, H5, H6, and H7. Topology information of the eight server nodes is shown in FIG. 3A. The sequence of the server nodes in the original node list is H4-H5-H3-H0-H6-H2-H7. The second server may perform the orchestration update on the sequence of the server nodes based on the topology information of the server nodes. For example, the second server may perform the orchestration update on the sequence of the server nodes level by level based on an order from the S layer to the L level. Specifically, for the S layer, arrangement may be performed based on an order of S0 to S1. To be specific, server nodes {H3, H0, H2, H1} that belong to the switching node S0 are arranged first, and then server nodes {H4, H5, H6, H7} that belong to the switching node S1 are arranged. After arrangement at the S layer is completed, arrangement is performed at the L level based on an order of L0 to L1. To be specific, server nodes that belong to the switching node L0 are arranged first, and then server nodes that belong to the switching node L1 are arranged, so that the orchestration node list can be obtained. The sequence of the server nodes in the orchestration node list is H0-H1-H2-H3-H4-H5-H6-H7. The orchestration update is performed on the sequence of the server nodes level by level based on the levels in the node communication network, to ensure that the server nodes in the orchestration node list are arranged level by level based on the levels in the node communication network, so that when collective communication is performed for the target collective operation by using the server nodes based on the sequence of the server nodes, cross-node communication can be reduced, and a communication delay of a collective operation in the collective communication can be reduced, thereby improving collective operation efficiency.

Operation 208: Perform collective communication for the target collective operation by using the server nodes based on the sequence of the server nodes in the orchestration node list.

For example, for the orchestration node list, a re-orchestration update is performed on the sequence of the server nodes. The second server performs collective communication for the target collective operation by using the server nodes based on the sequence of the server nodes. For example, the server nodes may sequentially perform the target collective operation, for example, sequentially perform the Allreduce operation, based on the sequence of the server nodes in the orchestration node list.

In the foregoing collective communication processing method, for the server nodes for the target collective operation in the original node list carried in the node orchestration request, the orchestration update is performed on the sequence of the server nodes level by level based on the topology information of the server nodes and the levels in the node communication network, to obtain the orchestration node list, and collective communication is performed for the target collective operation by using the server nodes based on the sequence of the server nodes in the orchestration node list. The orchestration update is performed on the sequence of the server nodes in the original node list level by level based on the levels in the node communication network. In this way, the sequence can be adjusted based on the topology information of the server nodes, and collective communication is performed for the target collective operation based on the sequence of the server nodes that is obtained through the orchestration update, so that generation of the cross-node communication can be reduced, and the communication delay of the collective operation in the collective communication can be reduced, thereby improving the collective operation efficiency.

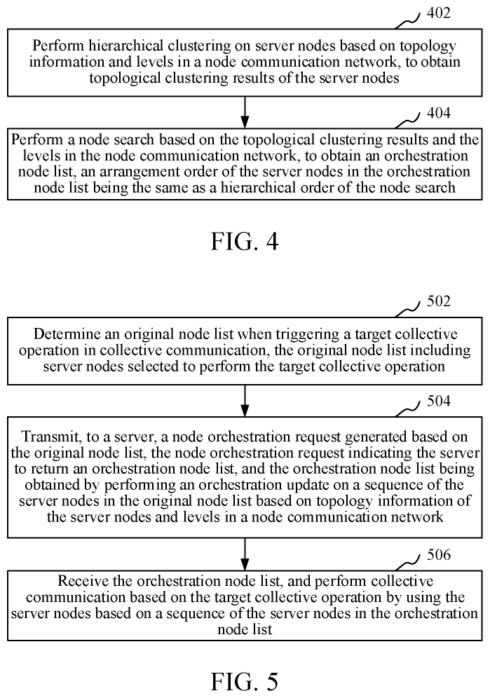

In one embodiment, as shown in FIG. 4, orchestration update processing, namely, the performing the orchestration update on the sequence of the server nodes level by level based on the topology information and the levels in the node communication network, to obtain an orchestration node list, includes:
Operation 402: Perform hierarchical clustering on the server nodes level by level based on the topology information and the levels in the node communication network, to obtain topological clustering results of the server nodes.

Switching nodes in the node communication network are divided into a plurality of levels, and server nodes connected to switching nodes at the same level need to communicate with each other by using a switching node at a previous level. Hierarchical clustering is performed on the server nodes level by level based on the levels of the switching nodes in the node communication network. Specifically, hierarchical clustering may be performed in ascending hierarchical order or in descending hierarchical order. In this way, a topology structure relationship of the server nodes in the node communication network can be accurately determined. For example, a switching node needed for communication between the server nodes can be determined. The topological clustering results may include hierarchical clustering results of the server nodes at each level.

For example, the second server may perform hierarchical clustering on the server nodes level by level based on the levels in the node communication network. For example, when the node communication network includes two levels, the second server may perform hierarchical clustering on the server nodes level by level based on an order from the first level to the second level based on the topology information of the server nodes, to obtain the topological clustering results of the server nodes. During specific implementation, the second server may perform hierarchical clustering on the server nodes based on the topology information of the server nodes and the first level, and classify server nodes connected to the same interaction node at the first level into the same category, to obtain a plurality of first-level clustering results. For each first-level clustering result, the second server may perform hierarchical clustering on the server nodes based on the topology information of the server nodes and the second level, and classify server nodes connected to the same interaction node at the second level into the same category, to obtain a plurality of second-level clustering results. Hierarchical clustering is performed for each first-level clustering result based on the second level, to obtain the plurality of second-level clustering results. Each first-level clustering result is traversed, to obtain the second-level clustering results of the first-level clustering result. The second server may obtain the topological clustering results of the server nodes based on the second-level clustering results of the first-level clustering result.

Operation 404: Perform a node search level by level based on the topological clustering results and the levels in the node communication network, to obtain the orchestration node list, the sequence of the server nodes in the orchestration node list being the same as a hierarchical order of the node search.

The node search may be implemented by performing a level-by-level search in ascending hierarchical order or in descending hierarchical order in the node communication network. The sequence of the server nodes in the orchestration node list is the same as the hierarchical order of the node search. That is, the sequence of the server nodes may be determined based on the hierarchical order of the node search. For example, in the orchestration node list, the server nodes may be sequentially arranged based on the hierarchical order of the node search.

In some embodiments, the second server may further perform the node search based on the topological clustering results of the server nodes, and specifically, perform the node search level by level based on the levels in the node communication network. During specific implementation, the hierarchical order of the node search may be the same as or different from a hierarchical order of hierarchical clustering. For example, hierarchical clustering may be implemented level by level in descending hierarchical order in the node communication network, and the node search may be implemented level by level in ascending hierarchical order in the node communication network. For example, when the node communication network includes two levels, the second server may perform the node search on the server nodes level by level based on the topological clustering results and an order from the second level to the first level, to obtain the orchestration node list. During specific implementation, the second server may perform the node search based on the topological clustering results and the second level, that is, search for a topological cluster a1 connected to a switching node A1 at the second level and a topological cluster a2 connected to a switching node A2 at the second level based on the topological clustering results. Server nodes in the topological cluster a1 are all connected to the switching node A1 at the second level, and server nodes in the topological cluster a2 are all connected to the switching node A2 at the second level. The second server separately performs the node search based on the first level in the topological cluster a1 and the topological cluster a2, to be specific, searches the topological cluster a1 for a topological cluster b1 connected to a switching node B1 at the first level and a topological cluster b2 connected to a switching node B2 at the first level, and searches the topological cluster a2 for a topological cluster b3 connected to a switching node B3 at the first level and a topological cluster b4 connected to a switching node B4 at the first level, so that {a1 [(b1), (b2)], a2 [(b3), (b4)]} can be obtained through the searches. (b1) and (b2) are obtained by further performing the node search based on a1 and the first level, and (b3) and (b4) are obtained by further performing the node search based on a2 and the first level, to obtain an orchestration node list {(b1), (b2), (b3), (b4)}. That is, arrangement is performed based on an order of (b1)-(b2)-(b3)-(b4).

In some embodiments, different orchestration node lists may be obtained through different node searches. For example, after the topological cluster a1 connected to the switching node A1 at the second level and the topological cluster a2 connected to the switching node A2 at the second level are searched for based on the topological clustering results, a further node search may be first performed for the topological cluster a2 to obtain the topological cluster b3 connected to the switching node B3 at the first level and the topological cluster b4 connected to the switching node B4 at the first level, and a further node search is then performed for the topological cluster a1, to obtain an orchestration node list {(b3), (b4), (b1), (b2)}. That is, arrangement is performed based on an order of (b3)-(b4)-(b1)-(b2). During specific application, when (b1), (b2), (b3), and (b4) include a plurality of server nodes, the plurality of server nodes in each of (b1), (b2), (b3), and (b4) may be randomly sorted. For example, when b1 includes a total of three server nodes, namely, b11, b12, and b13, in the orchestration node list, the interior of (b1) may be (b11, b12, b13), (b11, b13, b12), (b12, b11, b13), (b13, b11, b12), (b12, b13, b11),

### Or (b13, B12, B11).

In this embodiment, the second server performs hierarchical clustering on the server nodes level by level based on the topology information of the server nodes and the levels in the node communication network, and performs the node search level by level based on the topological clustering results obtained through level-by-level hierarchical clustering, thereby obtaining the orchestration node list in which the sequence of the server nodes conforms to the hierarchical order of the node search, to ensure that the server nodes in the orchestration node list are arranged level by level based on the levels in the node communication network, so that when collective communication is performed for the target collective operation by using the server nodes based on the sequence of the server nodes, the cross-node communication can be reduced, and the communication delay of the collective operation in the collective communication can be reduced, thereby improving the collective operation efficiency.

In one embodiment, the performing hierarchical clustering on the server nodes level by level based on the topology information and the levels in the node communication network, to obtain topological clustering results of the server nodes includes: performing hierarchical clustering on the server nodes level by level based on the topology information and a descending level dimension in the node communication network, to obtain the topological clustering results of the server nodes, where in the node communication network, a high-level switching node is configured to support cross-node communication between server nodes connected to low-level switching nodes.

The plurality of levels are set for the node communication network. Each level includes the at least one switching node. The high-level switching node is configured to support the cross-node communication between the server nodes connected to the low-level switching nodes. That is, when node communication is performed between server nodes respectively connected to different switching nodes at the same level, cross-node communication needs to be performed by crossing the switching nodes at the level, and specifically, is implemented by using a switching node at a higher level. For example, for switching nodes A and B at the same level, the switching node A is connected to a server node 1, and the switching node B is connected to a server node 2. In this case, during communication between the server node 1 and the server node 2, because at the level, the server node 1 and the server node 2 are connected to different switching nodes, and need to cross the switching nodes at the level to perform communication, which may be implemented by using a switching node C at a previous level of the level, a specific data transmission route may be the server node 1-the switching node A-the switching node C-the switching node B-the server node 2. Level-by-level hierarchical clustering may be implemented based on a descending level dimension or an ascending level dimension.

For example, the second server may determine a hierarchical order of the level-by-level hierarchical clustering, and may specifically perform hierarchical clustering on the server nodes level by level based on the topology information of the server nodes and the descending level dimension, to obtain the topological clustering results of the server nodes. Each topological clustering result may include a clustering result of hierarchical clustering of the server nodes at each level. For example, when the node communication network includes three levels, hierarchical clustering may be performed level by level based on hierarchical dimensions from the first level to the second level to the third level, or hierarchical clustering may be performed level by level based on hierarchical dimensions from the third level to the second level to the first level.

In this embodiment, the second server performs hierarchical clustering on the server nodes based on the descending level dimension, to accurately determine the clustering result of the server nodes at each level, and help accurately arrange the server nodes level by level based on the levels in the node communication network, so that the cross-node communication can be reduced, and the communication delay of the collective operation in the collective communication can be reduced, thereby improving the collective operation efficiency.

In one embodiment, the levels in the node communication network include a core layer, an aggregation layer, and an access layer in descending order; and the performing hierarchical clustering on the server nodes level by level based on the topology information and a descending level dimension in the node communication network, to obtain the topological clustering results of the server nodes includes: clustering the server nodes based on the topology information and a level dimension of the core layer, to obtain core layer clustering results of the server nodes; clustering the server nodes based on the core layer clustering results and a level dimension of the aggregation layer, to obtain aggregation layer clustering results of the server nodes; and clustering the server nodes based on the aggregation layer clustering results and a level dimension of the access layer, to obtain the topological clustering results of the server nodes.

The levels in the node communication network include the core layer (Core), the aggregation layer (Spine), and the access layer (Leaf) in descending order. The core layer may be the third level, the aggregation layer is the second level, and the access layer is the first level. That is, a switching node at the core layer is configured to support cross-node communication between server nodes connected to switching nodes at the second level or the first level. A switching node at the aggregation layer is configured to support cross-node communication between server nodes connected to a switching node at the first level. Hierarchical clustering may be performed level by level based on a hierarchical order of the core layer, the aggregation layer, and the access layer.

For example, for the node communication network including the core layer, the aggregation layer, and the access layer in descending order, the second server may cluster the server nodes based on the topology information and the level dimension of the core layer, and specifically classify server nodes connected to the same switching node at the core layer into the same cluster, to obtain the core layer clustering results of the server nodes. The second server clusters the server nodes based on the core layer clustering results and the level dimension of the aggregation layer, and specifically classifies server nodes connected to the same switching node at the aggregation layer into the same cluster, to obtain the aggregation layer clustering results. The second server clusters the server nodes based on the aggregation layer clustering results and the level dimension of the access layer, and specifically classifies server nodes connected to the same switching node at the access layer into the same cluster, to obtain the topological clustering results of the server nodes.

In this embodiment, for the node communication network including the core layer, the aggregation layer, and the access layer in descending order, the second server sequentially clusters the server nodes based on the hierarchical order of the core layer, the aggregation layer, and the access layer, to obtain topological clustering results reflected in clustering results at each level, help accurately arrange the server nodes level by level based on the levels in the node communication network, so that the cross-node communication can be reduced, and the communication delay of the collective operation in the collective communication can be reduced, thereby improving the collective operation efficiency.

In one embodiment, the performing a node search level by level based on the topological clustering results and the levels in the node communication network, to obtain the orchestration node list includes: performing the node search on the server nodes level by level based on the topological clustering results and a descending level dimension in the node communication network, to obtain the orchestration node list, where in the node communication network, a high-level switching node is configured to support cross-node communication between server nodes connected to low-level switching nodes.

The plurality of levels are set for the node communication network. Each level includes the at least one switching node. The high-level switching node is configured to support the cross-node communication between the server nodes connected to the low-level switching nodes. That is, when node communication is performed between server nodes respectively connected to different switching nodes at the same level, cross-node communication needs to be performed by crossing the switching nodes at the level, and specifically, may be implemented by using a switching node at a higher level.

Specifically, the second server may determine the hierarchical order of the level-by-level node search, and may specifically perform the node search on the server nodes level by level based on the topological clustering results of the server nodes and the descending level dimension, to obtain the orchestration node list of the server nodes. For example, when the node communication network includes three levels, the node search may be performed for the topological clustering results level by level based on the level dimensions from the first level to the second level to the third level, or the node search may be performed level by level based on the level dimensions from the third level to the second level to the first level.

In this embodiment, the second server performs the node search on the server nodes based on the descending level dimension, and accurately arranges the server nodes level by level based on the levels in the node communication network, so that the cross-node communication can be reduced, and the communication delay of the collective operation in the collective communication can be reduced, thereby improving the collective operation efficiency.

In one embodiment, the levels in the node communication network include a core layer, an aggregation layer, and an access layer in descending order; and the performing the node search on the server nodes level by level based on the topological clustering results and a descending level dimension in the node communication network, to obtain the orchestration node list includes: performing a search based on the topological clustering results and a level dimension of the core layer, to obtain core layer search results; performing a search based on the core layer search results and a level dimension of the aggregation layer, to obtain aggregation layer search results; performing a search based on the aggregation layer search results and a level dimension of the access layer, to obtain access layer search results; and obtaining the orchestration node list based on the core layer search results, the aggregation layer search results, and the access layer search results.

The levels in the node communication network include the core layer, the aggregation layer, and the access layer in descending order. In some embodiments, for the node communication network including the core layer, the aggregation layer, and the access layer in descending order, the second server may perform a search based on the topological clustering results and the level dimension of the core layer, and specifically, for each switching node at the core layer, searches, based on the topological clustering results, for server nodes connected to the corresponding switching node, to obtain a core layer search result. The core layer search result may record the server nodes connected to the switching node at the core layer. The server nodes connected to the switching node may be in direct communication connection, or may be in indirect communication connection via switching nodes at other levels. The second server performs a search based on the core layer search results and the level dimension of the aggregation layer, and specifically, for each switching node at the aggregation layer, searches, based on the core layer search results, for server nodes connected to a corresponding switching node, to obtain the aggregation layer search results. The aggregation layer search result may include the server nodes connected to the switching node at the aggregation layer. The second server performs a search based on the aggregation layer search results and the level dimension of the access layer, and specifically, for each switching node at the access layer, searches, based on the aggregation layer search results, for server nodes connected to a corresponding switching node, to obtain the access layer search results. The access layer search result may include the server nodes connected to the switching node at the access layer.

The second server may synthesize the core layer search results, the aggregation layer search results, and the access layer search results, to obtain the orchestration node list. Specifically, the second server may sort and combine the server nodes based on a level search order of the core layer, the aggregation layer, and the access layer, the core layer search results, the aggregation layer search results, and the access layer search results, to obtain the orchestration node list. For example, the core layer search results include c1, c2, and c3, which respectively correspond to switching nodes C1, C2, and C3 at the core layer. For c1, c2, and c3, in the aggregation layer search results obtained through a search based on the level dimension of the aggregation layer separately, s1 and s2 are obtained through a search based on c1, s3 and s4 are obtained through a search based on c2, and s5 and s6 are obtained through a search based on c3. s1, s2, s3, s4, s5, and s6 respectively correspond to switching nodes S1, S2, S3, S4, S5, and S6 at the aggregation layer. For s1, s2, s3, s4, s5, and s6, in the access layer search results obtained through a search based on the level dimension of the access layer separately, l1 and l2 are obtained through a search based on s1, l3 and l4 are obtained through a search based on s2, l5 and l6 are obtained through a search based on s3, l7 and l8 are obtained through a search based on s4, l9 and l10 are obtained through a search based on s5, l11 and l12 are obtained through a search based on s6. l1, l2, l3, l4, l5, l6, l7, l8, l9, l10, l11, and l12 respectively correspond to switching nodes L1, L2, L3, L4, L5, L6, L7, L8, L9, L10, L11, and L12 at the access layer. The second server may sort the server nodes based on c1, c2, and c3, s1, s2, s3, s4, s5, and s6, l1, l2, l3, l4, l5, l6, l7, l8, l9, l10, l11, and l12, to obtain the orchestration node list in which the sequence of the server nodes conforms to the hierarchical order of the node search. For example, the orchestration node list may be {l1, l2, l3, l4, l5, l6, l7, l8, l9, l10, l11, l12}, or may be {l12, l11, l10, l9, l8, l7, l6, l5, l4, l3, l2, l1}.

In this embodiment, for the node communication network including the core layer, the aggregation layer, and the access layer in descending order, the second server sequentially performs a search for the topological clustering results based on the hierarchical order of the core layer, the aggregation layer, and the access layer, to obtain the orchestration node list, and arrange the server nodes level by level based on the levels in the node communication network, so that the cross-node communication can be reduced, and the communication delay of the collective operation in the collective communication can be reduced, thereby improving the collective operation efficiency.

In one embodiment, the obtaining a node orchestration request for a target collective operation in collective communication includes: determining a collective communication library in the collective communication; and obtaining the node orchestration request for the target collective operation in the collective communication based on a communication interface to the collective communication library.

The collective communication library is a library configured for supporting communication between a plurality of processes in parallel computing. In a parallel computing environment, a plurality of processes may need to cooperatively work to complete a task, and the collective communication library provides a high-efficiency collective operation, so that these processes can conveniently perform operations such as data exchange and synchronization. For example, the second server may determine the collective communication library in the collective communication, where the collective communication library includes various collective operations. That is, the corresponding collective operations are implemented based on the collective communication library. The collective communication library may include, but is not limited to, at least one of communication libraries such as a message passing interface (MPI), an NVIDIA collective communication library (NCCL), Libfabric, or intel threading building blocks (TBB). The second server obtains, through the communication interface to the collective communication library, the node orchestration request for the target collective operation. The second server may use the communication interface to the collective communication library based on a plugin of the collective communication library.

In this embodiment, the second server obtains the node orchestration request for the target collective operation through the communication interface to the collective communication library, thereby accurately and quickly obtaining the node orchestration request including the original node list, and helping improve collective communication efficiency for the target collective operation.

In one embodiment, the obtaining topology information of the server nodes includes: determining a topology database associated with the node communication network; and querying the topology database for the topology information of the server nodes based on the original node list.

The topology database is configured to record a level topology structure in the node communication network and server nodes connected to switching nodes. Specifically, the second server may determine the topology database associated with the node communication network, and query the topology database for the topology information of the server nodes based on the original node list carried in the node orchestration request. During specific implementation, the original node list may include the node identifiers of the server nodes for the target collective operation, and the second server may query the topology database for the topology information of the identified server nodes based on the node identifiers. The topology information may include the node identifiers of the server nodes and the node identifiers of the connected switching nodes.

In this embodiment, the second server queries, based on the original node list, the topology database associated with the node communication network for the topology information of the server nodes. In this way, the orchestration update can be performed on the sequence of the server nodes level by level based on the levels in the node communication network by using the topology information of the server nodes, and collective communication is performed for the target collective operation based on the sequence of the server nodes that is obtained through the orchestration update, so that generation of the cross-node communication can be reduced, and the communication delay of the collective operation in the collective communication can be reduced, thereby improving the collective operation efficiency.

In one embodiment, the obtaining a node orchestration request for a target collective operation in collective communication includes: obtaining the node orchestration request from a target server node, the target server node being determined in the server nodes selected to perform the target collective operation in the collective communication.

The target server node determined in the server nodes for the target collective operation may specifically include a server node that is in the server nodes and that initiates the collective communication for the target collective operation. For example, the second server determines the target server node, and obtains the node orchestration request from the target server node. During specific implementation, the node orchestration request may be actively sent by the target server node to the second server. In this case, the second server may directly receive and obtain the node orchestration request sent by the target server node.

Further, the performing collective communication for the target collective operation by using the server nodes based on the sequence of the server nodes in the orchestration node list includes: transmitting the orchestration node list to the target server node, the orchestration node list indicating the target server node to perform collective communication based on the target collective operation by using the server nodes based on the sequence of the server nodes in the orchestration node list.

Specifically, after the orchestration update is performed on the original node list carried in the node orchestration request sent by the target server node, the second server may transmit the orchestration node list to the target server node, so that the target server node performs collective communication based on the target collective operation by using the server nodes based on the sequence of the server nodes in the orchestration node list. That is, the target server node initiates collective communication processing for the target collective operation.

In this embodiment, the second server obtains the node orchestration request from the target server node, and transmits the orchestration node list to the target server node. In this way, the target server node initiates the collective communication for the target collective operation based on the orchestration node list, so that generation of the cross-node communication can be reduced, and the communication delay of the collective operation in the collective communication can be reduced, thereby improving the collective operation efficiency.

In one embodiment, the collective communication processing method further includes: performing, when the server nodes for the target collective operation meet an orchestration update trigger condition, the operation of the obtaining a node orchestration request for a target collective operation in collective communication.

The orchestration update trigger condition is configured for determining whether orchestration update processing on the server nodes needs to be triggered. For example, when the server nodes for the target collective operation are updated, it may be considered that the orchestration update trigger condition is met. For example, when there is a faulty node in the server nodes for the target collective operation, or a new server node is added, it may be considered that the orchestration update trigger condition is met. For example, the second server may monitor the server nodes for the target collective operation, and may specifically detect status changes of the server nodes. When detecting that the orchestration update trigger condition is met, for example, when the second server detects that there is a faulty node in the server nodes for the target collective operation, or the new server node is added, the server performs the operation of the obtaining a node orchestration request for a target collective operation in collective communication, to perform, in time, the orchestration update on the sequence of the server nodes whose statuses change.

In this embodiment, when detecting that the orchestration update trigger condition is met, the second server performs the operation of the obtaining a node orchestration request for a target collective operation in collective communication, to perform, in time, the orchestration update on the sequence of the server nodes whose statuses change, thereby helping improve the collective operation efficiency.

In one embodiment, as shown in FIG. 5, a collective communication processing method is provided. The method is performed by a computer device. Specifically, the method may be independently performed by the computer device like a terminal or a server, or may be jointly performed by the terminal and the server. In this embodiment, an example in which the method is applied to the first server in FIG. 1 is used for description. The method includes the following operation 502 to operation 506:
Operation 502: Determine an original node list when triggering a target collective operation in collective communication, the original node list including server nodes selected to perform the target collective operation.

The target collective operation is a collective operation that is currently triggered in the collective communication and that needs to be performed. The original node list includes the server nodes selected to implement the target collective operation, and the server nodes are nodes selected to implement the target collective operation. That is, the target collective operation is implemented between the selected server nodes.

For example, when the target collective operation in the collective communication is triggered, it indicates that the target collective operation needs to be performed, and the first server may determine the corresponding original node list. The original node list includes the server nodes for the target collective operation. The first server is a node in the server nodes for the target collective operation.

Operation 504: Transmit, to a server, a node orchestration request generated based on the original node list, the node orchestration request indicating the server to return an orchestration node list, and the orchestration node list being obtained by performing an orchestration update on an sequence of the server nodes in the original node list level by level based on topology information of the server nodes and levels in a node communication network.

The node orchestration request is generated based on the original node list. The node orchestration request is configured to request the orchestration update on the sequence of the server nodes for the target collective operation. The topology information describes switching nodes connected to the server nodes at the levels in the node communication network, to perform communication at corresponding levels by using the connected switching nodes. The node communication network may include a plurality of switching nodes, configured to perform data packet forwarding between servers. The switching nodes in the node communication network may be constructed based on a multi-level structure. Each level may include at least one switching node. The server nodes communicate with each other based on the switching nodes connected at the levels. The orchestration update on the sequence of the server nodes level by level may be implemented based on a descending or ascending level dimension.

In some embodiments, the first server generates the node orchestration request based on the original node list, and transmits the node orchestration request to the server, to indicate the server to perform the orchestration update on the sequence of the server nodes in the original node list level by level based on the topology information of the server nodes and the levels in the node communication network, and return the orchestration node list obtained through the orchestration update.

Operation 506: Receive the orchestration node list, and perform collective communication based on the target collective operation by using the server nodes based on an sequence of the server nodes in the orchestration node list.

Specifically, for the orchestration node list, a re-orchestration update is performed on the sequence of the server nodes. The first server performs collective communication for the target collective operation by using the server nodes based on the sequence of the server nodes. For example, the first server may initiate the target collective operation based on the sequence of the server nodes in the orchestration node list, to control the server nodes to sequentially perform the target collective operation, for example, sequentially perform an Allreduce operation.

In the foregoing collective communication processing method, when the target collective operation in the collective communication is triggered, the original node list including the server nodes for the target collective operation is determined, the node orchestration request generated based on the original node list is sent to the second server, the orchestration node list that is returned by the server and that is obtained by performing the orchestration update on the sequence of the server nodes in the original node list is received, and collective communication is performed for the target collective operation by using the server nodes based on the sequence of the server nodes in the orchestration node list. For the server nodes for the target collective operation, the orchestration node list obtained by performing the orchestration update on the sequence of the server nodes level by level based on the levels in the node communication network is obtained, and collective communication is performed for the target collective operation based on the sequence of the server nodes in the orchestration node list, so that generation of cross-node communication can be reduced, and a communication delay of the collective operation in the collective communication can be reduced, thereby improving collective operation efficiency.

This application further provides an application scenario. The foregoing collective communication processing method is applied to the application scenario. Specifically, application of the collective communication processing method in the application scenario is as follows:

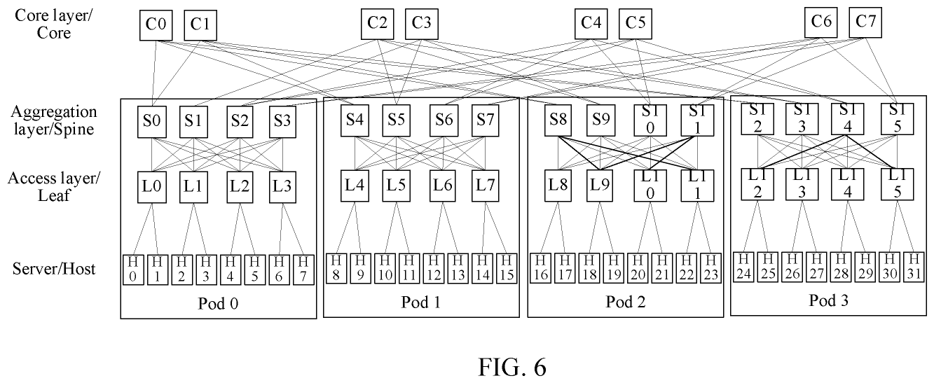

A modern data center network generally has a Clos architecture. To be specific, three layers or two layers of switching nodes are disposed. The switching nodes may be specifically switches. As shown in FIG. 6, three layers, which are an access layer, an aggregation layer, and a core layer from a low level to a high level, of switches and one layer of server nodes are included. The server nodes are specifically servers (Hosts). The core layer includes a total of eight switches (namely, switching nodes) C0 to C7, the aggregation layer includes a total of 16 switches S0 to S15, the access layer includes a total of 16 switches L0 to L15, and a server layer includes a total of 32 servers H0 to H31. A switch is only responsible for forwarding a data packet, and all service application is deployed on a server. A switch at the access layer and a server to which the switch is downlinked are collectively referred to as a rack (or block). A group of interconnected switches at the aggregation layer and the access layer and servers to which the switches are downlinked form a network module (or Pod). For example, in FIG. 6, a switch L0 at the access layer and servers H0 and H1 to which the switch L0 is downlinked form a rack. All devices in the first dashed box form a Pod. It can be learned that inter-rack server communication needs to be performed up to a switch at the aggregation layer. For example, communication between H0 and H2 needs to be performed through one or more switches in S0 to S3. Cross-pod server communication needs to be performed up to a switch at the core layer. For example, communication between H0 and H8 needs to be performed through one or more switches in switches C0 to C7 at the core layer.

Currently, all mainstream large-scale artificial intelligence (AI) models are trained by using a high performance computing (HPC) cluster including distributed servers in a data center network. In such a computing cluster, a plurality of servers equipped with a high-performance graphics processing unit (GPU) perform cooperative training by using a high-bandwidth network, for example, an RDMA over Converged Ethernet (RoCEv2) network or an InfiniBand (IBB) network. RDMA refers to remote direct memory access. In a typical training task, a master server coordinates, based on a training framework, for example, based on TensorFlow or PyTorch, a group of servers to perform training. Load of cluster training includes a computing task and a communication task. The computing task means that a GPU of a server performs mathematical computation on the AI model. The communication task mainly means synchronizing and coordinating computation results of servers, and is embodied as data transmission between the servers. Usually, the communication task is implemented based on a collective communication operation in a collective communication library (for example, an MPI, an NCCL, or libfabric), for example, Allreduce (global Allreduce), Alltoall, or Allgather. An Nvidia collective communication library (NCCL) is a most widely used collective communication library in the large model training industry currently, and Allreduce is a most basically and most frequently used collective communication operation. In Allreduce, each node transmits data thereof, also receives data sent by another node in a group, and generates a summarization result. In this embodiment, for the Allreduce operation, throughput thereof is improved through data flow orchestration scheduling.

Allreduce is usually implemented by using a parameter-server (PS) architecture in conventional training. However, completion time of the Allreduce operation of the PS architecture is in direct proportion to a node number, which means that it is quite difficult to scale the PS architecture up to a large-scale network. A peer architecture emerges, and this architecture can resolve a problem of scalability well. In the peer architecture, training mainly relies on the distributed Allreduce collective operation to complete data synchronization. Implementation of the distributed Allreduce operation includes a Ring Allreduce operation, a Tree Allreduce operation, a Halving-Doubling Allreduce operation, and the like and variations thereof. Ring Allreduce is a most widely used Allreduce implementation, and the NCCL is based on the peer architecture and uses the distributed Allreduce operation to perform parameter synchronization.

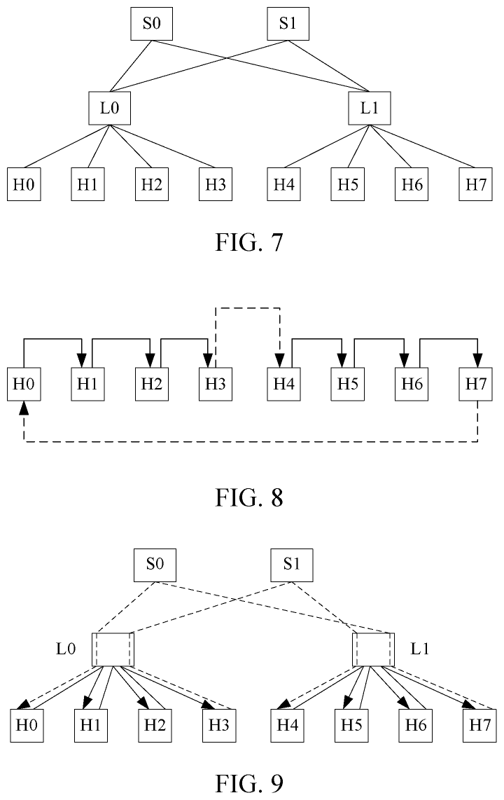

During logical implementation of Ring Allreduce, the master server strings all servers (one server usually has a plurality of GPUs) into a loop, and data is sequentially transmitted from one server to a next server along the loop until all the servers receive data of all other servers. Transmitted data volumes of all communication pairs (for example, H1->H2) are the same. In this loop, completion time of the Allreduce communication operation is equal to transmission time of a slowest communication pair. That is, a decrease in a rate of any communication pair becomes a bottleneck of collective communication, and slows down an entire collective communication operation. In an actual network, as shown in FIG. 7, there are a total of eight servers H0 to H7 participating in Ring Allreduce. Servers H0, H1, H2, and H3 are directly connected to a switch L0 at an access layer, and servers H4, H5, H6, and H7 are directly connected to a switch L1 at the access layer. When processing is performed based on Ring Allreduce, an optimal logical traffic ring formed by the servers is shown in FIG. 8. In the optimal logical traffic ring of Ring Allreduce, a solid-line arrow indicates intra-rack traffic, a dashed-line arrow indicates inter-rack traffic, and data is transmitted from a direction pointed by an arrow tail to a direction pointed by an arrow head. Corresponding actual network traffic is shown in FIG. 9. It can be learned that, in the ring, six communication processes are intra-rack communication processes, and the two other communication processes are inter-rack communication processes. Because intra-rack communication passes through only one hop of switch, there is no risk of congestion (rate decrease). Inter-rack communication may cause a rate decrease because a physical link is shared with another data flow, and the another data flow herein may also belong to this Allreduce operation. Inter-rack traffic has two risks: First, it is prone to congestion with other traffic, leading to a rate decrease, and second, a delay is significantly higher than that of intra-rack communication. Therefore, during model training, inter-rack traffic needs to be reduced as much as possible in an Allreduce operation. FIG. 8 and corresponding network traffic FIG. 9 are an optimal traffic orchestration case. Inter-rack traffic (a dashed line) has been minimized, and there is only a forward group (H3->H4) and a reverse group (H7->H0).

In an actual large-scale production environment, especially in a multi-tenant HPC training cluster provided by a cloud manufacturer, there is a cloud environment service deployment feature. To be specific, server nodes provided for tenants may be arranged discontinuously in terms of physical locations, and a server list provided for the tenants is always out of order. There are mainly the following reasons:

Blocking of the physical locations from the tenants: To prevent the tenants from proposing an insatiable requirement (for example, the requirement is being in one rack) on a server physical location aspect, and to maximize server resource utilization, a manufacturer needs to present the tenants with an effect of “all server resources have equivalent capabilities”.

Quite high server lease dynamism: Because the tenants can flexibly increase or decrease a number of leased servers at any time, locations of idle/leasable servers may be quite scattered. In this way, if an existing tenant needs to incrementally purchase a server subsequently or a new tenant purchases a server, server physical locations obtained by the tenants may be discontinuous. In addition, due to a purchase time order, even if server locations are continuous, an order presented by servers in the list may be a result of out of order.

Replacement due to a server fault: Because performance and power requirements of an HPC training scenario are both quite high, fault rates (including a GPU fault, a network adapter fault, an entire system fault, and the like) of these servers are high, and a scenario in which a faulty server needs to be replaced often occurs. Because of time urgency, server replacement is redundant hot standby replacement. That is, several servers in a cluster are deliberately unsold. When a server is faulty, a redundant server is given to a tenant for use, and the faulty server is still in situ, and waits for physical repair or replacement. After physical repair or replacement is completed, the faulty server is sold again. In this way, for the tenant, a newly added server is directly added to an existing server list (added at the end). Therefore, the server list obtained by the tenant is usually disordered in terms of physical distribution.

Existing collective communication libraries (for example, the NCCL) can sense and optimize an intra-node GPU interconnection topology through operating system query, but do not have a capability of sensing a topology order of a plurality of server nodes. A current case is that a tenant usually receives a server node list from a cloud operator, and transmits the list to a collective communication library, and then the communication library orchestrates nodes into a traffic topology ring based on an order of the nodes in the list, to perform the Ring Allreduce operation. However, as shown in FIG. 8 and FIG. 9, FIG. 8 and FIG. 9 correspond to optimal cases. In an actual service scenario, limited by the foregoing cloud environment deployment capability, the node list received by the tenant is always out of order. In this case, actual collective operation efficiency may be seriously reduced (a typical value of a reduction ratio is 50%). Although Ring Allreduce is a most commonly used Allreduce implementation, other implementations of Allreduce may also be applied, such as Tree Allreduce and Halving-Doubling Allreduce. Likewise, these Allreduce implementations may also be affected by a topology order of the servers, and embodiments are also applicable to these implementations.

It can be learned that performance of distributed Ring Allreduce greatly depends on good topology affinity and a network capability. Under optimal topology orchestration, as shown in FIG. 8, machines in one rack generate only one group of uplink traffic and one group of downlink traffic. As shown in FIG. 9, four servers (H0 to H3) of a switch L0 in a rack 1 generate only a group of uplink traffic (a dashed line) to a rack 2 via S1, and four servers (H4 to H7) of a switch L1 in the rack 2 also generate a group of uplink traffic (a dashed line) to the rack 1 via S0. The uplink traffic of the rack 1 is downlink traffic of the rack 2, and vice versa. In this way, because a single group of traffic of each rack is sent from only one server, the traffic does not cause congestion in any uplink of the switch at the access layer, and a network is naturally quite smooth.

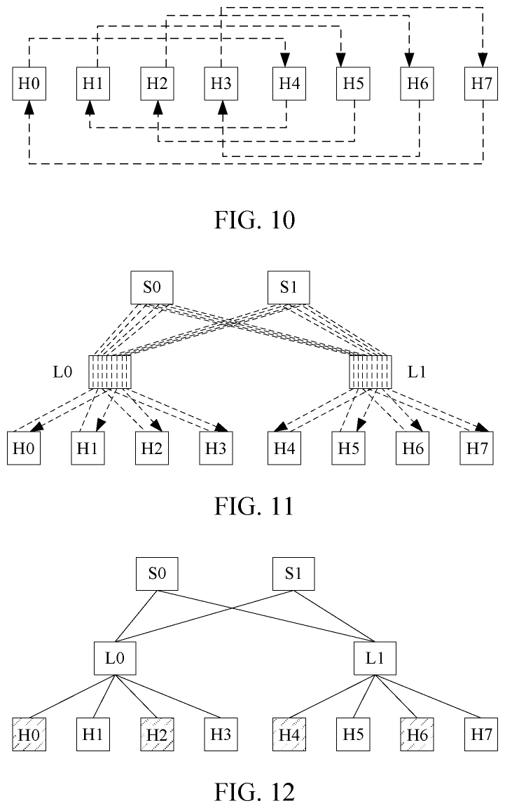

However, during actual training, if a topology received by a communication library is not an optimal topology, a traffic ring formed by the communication library is always not a smallest ring, and a plurality of groups of traffic that cross switches at the aggregation layer and even the core layer occur in the ring. As shown in FIG. 10, in a traffic logic ring of eight servers H0 to H7, as a single-tenant worst case, communication between all servers generates cross-level traffic. As shown in FIG. 11, in a traffic topology ring of the single-tenant worst case, communication between all servers crosses a switch at the access layer, and is implemented by using a switch at the aggregation layer. Due to a defect of load balancing of a switch (route hashing has randomness), the plurality of groups of uplink traffic always cause congestion to some extent, causing a decrease in throughput between some node pairs. A characteristic of the ring-shaped traffic determines that overall performance of a system is limited by a connection with minimum throughput (bottleneck). Therefore, congestion caused by a non-optimal traffic topology seriously affects overall performance of an HPC system. For example, if an orchestrated logical topology ring is shown in FIG. 10, to be specific, if the loop is H0-H4-H1-H5-H2-H6-H3-H7-H0, four groups of inter-rack uplink traffic (via the switch at the aggregation layer) and four groups of inter-rack downlink traffic are generated in the network. Two cases are discussed below.

If a network bandwidth is convergent, to be specific, a total downlink bandwidth of L0 is greater than a total uplink bandwidth, the plurality of groups of traffic inevitably cause severe congestion, a bottleneck of quite poor throughput is generated, and system performance is greatly lost. As shown in FIG. 11, L0 has four groups of uplink traffic entering a link to S0. It is assumed that each link bandwidth is 100 G. Because each group of uplink traffic has a maximum of 100 G, four groups have a total of 400 G, and a bandwidth of an L0-S0 link also has only 100 G, this results in that an actual bandwidth of each group of uplink traffic has only 25 G (if congestion control fairness is poor, a specific group of traffic is less than 25 G), and finally results in that throughput of an entire system has only 25 G (because a topology of traffic is ring-shaped, throughput of an entire ring is limited by throughput of a bottleneck point).

Even if a network bandwidth is not convergent, to be specific, a total downlink bandwidth of L0 is equal to a total uplink bandwidth, individual links may be congested due to a load balance imperfection, finally affecting system performance. As shown in FIG. 11, it is assumed that connections L0-S0 and L0-S1 are both two 100 G links. Due to an imperfection of load balance hashing of a switch, there is a high probability (90%) that there are two or more groups of traffic entering the same 100 G link in four groups of uplink traffic. In this case, the throughput of the entire system may decrease to 50 G or even lower.

The foregoing discussion is only for the small-scale network shown in FIG. 6. In an actual large-scale network, randomness of performance is higher, and non-optimized system performance may differ from optimal performance more. For example, in an actual production network, one rack/block usually has 32 servers. In a worst case, one rack transmits 32 groups of inter-rack traffic. There is a high probability that there are at least two groups of traffic that are congested to one port in uplink route hashing in so much traffic. In this case, actual throughput of the congested traffic is reduced to 50% or less of ideal throughput. However, in the Ring Allreduce operation, provided that a bottleneck occurs in the ring, throughput of the entire operation is hurt by the bottleneck, and consequently, completion time of the entire operation is increased to at least twice ideal time. To sum up, a server node list presented by a manufacturer to a tenant has no topology affinity guarantee. Actually, a node name always includes some random letters and numbers, and no topology affinity can be learned from a node name in a list. In addition, an internet protocol (IP) address of a node also does not have information that can identify a physical location. For a tenant, if the tenant directly uses a node list provided by a cloud manufacturer as an input list of a collective communication library in collective communication, a result that performance is lower than expectation may occur. In addition, for the cloud manufacturer, due to randomness of load balancing in a network, even if a network topology is not convergent on a bandwidth design (that is, a downlink bandwidth and an uplink bandwidth of LA are the same), HPC performance obtained by a tenant is random (inconsistent), and expectation is difficult.

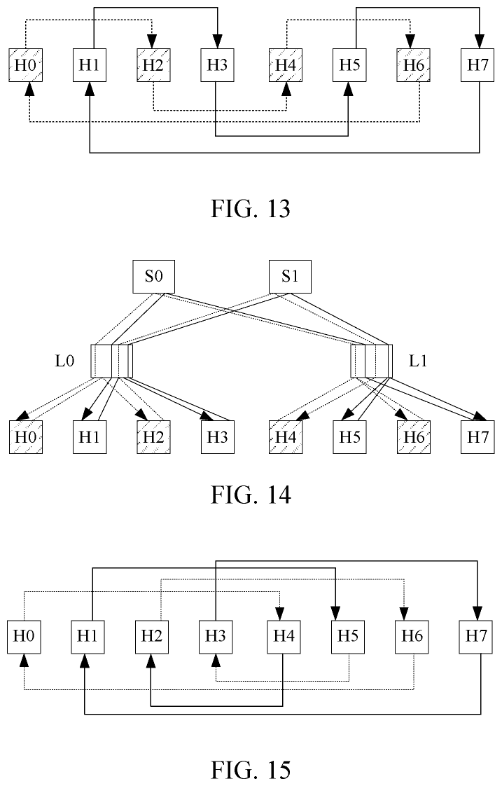

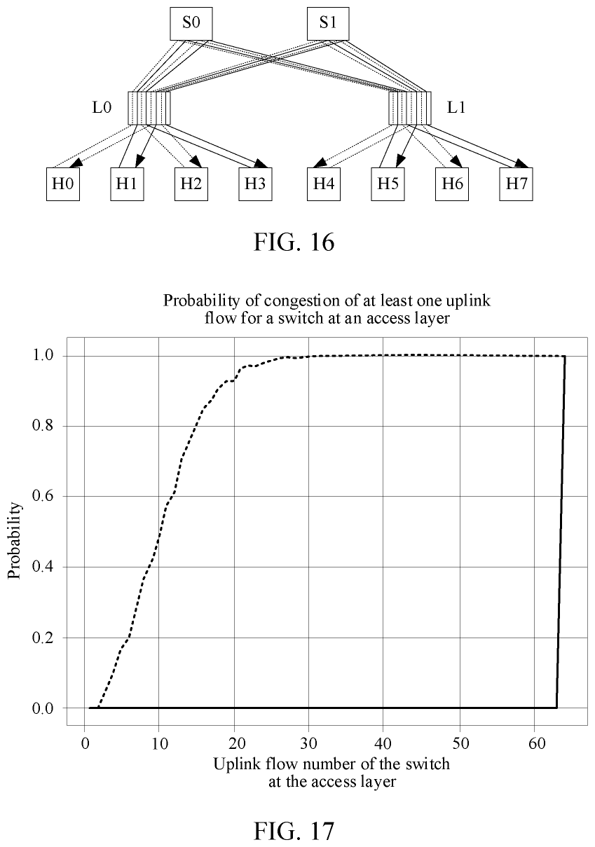

In addition, the foregoing cases are all for a single-tenant scenario. In a cloud deployment environment, there are a plurality of tenants. That is, servers of the plurality of tenants are hybrid deployed in the same network. In a multi-tenant scenario, even if in a most ideal case, there are a plurality of groups of inter-rack traffic in a network. If a multi-tenant traffic topology is not optimized, there is more inter-rack traffic, bringing more performance uncertainty to model training, and further causing a non-negligible impact to a service-level agreement (SLA) commitment of a manufacturer to a tenant. For example, as shown in FIG. 12, in a multi-tenant server hybrid deployment scenario, if there are servers of two tenants, where servers leased by a tenant 1 include servers H0, H2, H4, and H6 that are filled with oblique lines, and servers leased by a tenant 2 include unfilled servers H1, H3, H5, and H7. In an ideal case, if traffic topologies of tenants are optimized, logical traffic topologies and network traffic of the tenants are respectively shown in FIG. 13 and FIG. 14. A dashed line represents a traffic topology between the servers H0, H2, H4, and H6 of the tenant 1, and a solid line represents a traffic topology between the servers H1, H3, H5, and H7 of the tenant 2. Each switch at the access layer has two groups of uplink traffic, and the two groups of traffic have a smaller probability of congestion. However, if a traffic topology of each tenant is not optimized, as shown in FIG. 15 and FIG. 16, each switch at the access layer has four groups of uplink traffic. There is a much larger probability that the four groups of traffic are congested. In addition, a delay of performing the Ring Allreduce operation for a non-optimized topology is also much higher.

In an actual network, one rack has eight Leaf switches and 32 servers, and each server has eight network adapters. One Leaf switch accesses 64 ports in a downlink, and is also connected to 64 ports in an uplink. In an extreme case, one Leaf switch has 64 groups of inter-rack traffic in an uplink. A relationship between a number of inter-rack flows and a congestion probability is analyzed and characterized. FIG. 17 is a diagram of a probability of congestion of at least one uplink flow for a switch at an access layer (Probability of at least one LA uplink congestion). A horizontal coordinate is an uplink flow number of the switch at the access layer, and a vertical coordinate is the probability. In a relationship between the number of uplink flows of the Leaf switch and a congestion probability, a dashed line is a curve of non-optimized/random, and a solid line is a probability curve of topology optimization orchestration when a single tenant uses Ring Allreduce. It can be learned that, after a number of Leaf uplink flows exceeds 20, even if the switch has 64 uplink flows, the probability of congestion of at least one link exceeds 90%. However, after a number of uplink flows exceeds 30, congestion (at least one link) almost certainly occurs (a probability approaches 100%).

For the foregoing practical reasons, in embodiments, optimization orchestration is performed on the server node list of the tenant (for example, optimized from FIG. 10 to FIG. 8). The optimized traffic topology can minimize uplink traffic of each rack (as shown in FIG. 8), thereby minimizing congestion of uplink traffic of the switch at the access layer, improving network smoothness, and maximizing network throughput of a tenant. Particularly, when there is only one tenant in a rack, in embodiments, it can be achieved that there is only one group of uplink traffic in the entire rack, there is no congestion in an uplink direction of the switch at the access layer, and tenant throughput can reach an ideal level.

In embodiments, use of a collective communication library in large model training may be assisted by using a component manner. Large model training once always has a plurality of collective operations simultaneously, and servers of the plurality of collective operations usually do not overlap. For example, in three-dimensional (3-D) parallel training (model parallelism, pipelining parallelism, and data parallelism), all GPUs participate in an Allreduce operation on a data parallelism surface to synchronize training results on different data parallelism surfaces, and there are dozens of Allreduce operations in total. Each collective communication operation has a master server, and the master server initiates the entire operation. During actual training, for example, in this solution, a master server of each collective communication operation needs to initiate a topology optimization orchestration request (the request is completed by a topology optimization agent component on the server). After receiving the request, a controller performs optimization orchestration on a server list in the request, to increase affinity of collective communication, reduce a delay of the communication operation and network congestion, and improve throughput of the collective communication, thereby reducing training time of large model training.

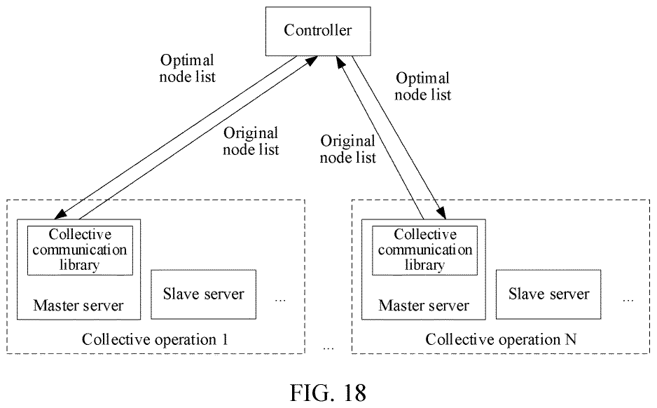

According to the collective communication processing method provided in embodiments, when a large-scale AI training cluster, for example, a high-performance computing cluster (HCC) product is deployed, the topology optimization agent component on the server side may be implemented in a form of an NCCL plugin, and the controller is implemented by a dedicated server, and may be specifically connected to a corresponding network topology database. As shown in FIG. 18, for different collective operations, each collective operation is implemented by using a plurality of servers. The plurality of servers include one master server and several slave servers. A collective communication library may be disposed in the master server, and may be specifically the NCCL. The master server may transmit the original node list to the controller, and the controller returns an optimal node list obtained by performing the orchestration update on the original node list, so that the master server initiates a corresponding collective operation based on the received optimal node list.

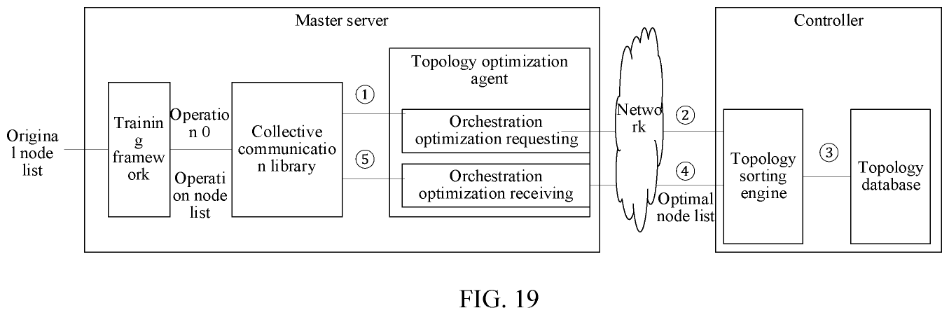

Specifically, in an actual service, after purchasing a server, a tenant obtains a group of original server node lists. During model training, the tenant allocates a server resource by using a training framework (for example, TensorFlow or PyTorch). When a collective operation is performed, the training framework transmits some node lists to the collective communication library (for example, the NCCL or the MPI). Generally, during model training, not all servers are configured for the same collective operation. Each collective operation is only a part of the training. There are a plurality of collective operations in the entire training, and only some servers are configured for each collective operation. When invoking the collective communication library to complete the collective operation, the training framework transmits a server list (an operation node list) configured for the operation to the collective communication library. As shown in FIG. 19, in operation 0, a training framework of a master server obtains all original node lists, uses an operation node list as an original node list, and transmits the operation node list to a collective communication library.

Further, composition of embodiments mainly includes: a topology optimization agent on a server side and a centralized controller that provides a topology sorting capability. The controller may be a physically independent server, or may be a logical module in an existing server. The agent and the controller communicate with each other in a “request-answer” manner through a network. In embodiments, the collective communication library may be slightly modified, and a topology optimization request interface is added. In some communication libraries, the communication library may not be modified, but a plugin component of the communication library may be modified. For example, the NCCL has a plugin function interface, and only the interface needs to be added to the NCCL plugin.

As shown in FIG. 19, operation \textcircled{1}: when receiving a collective communication operation command, the collective communication library of the master server first requests topology orchestration optimization from the topology optimization agent in this solution. Operation \textcircled{2}: After receiving the request from the collective communication library, the topology optimization agent requests topology sorting from the controller through the network. Operation \textcircled{3}: After receiving the request, a topology sorting engine on the controller first queries a topology database. Operation \textcircled{4}: The controller performs sorting based on topology information of each server node, and then returns a sorted server list back to the topology optimization agent. Operation \textcircled{5}: After receiving a topology orchestration optimization answer, the topology optimization agent returns a result to the collective communication library of the master server, and the collective communication library initiates collective communication by using the orchestrated server list.

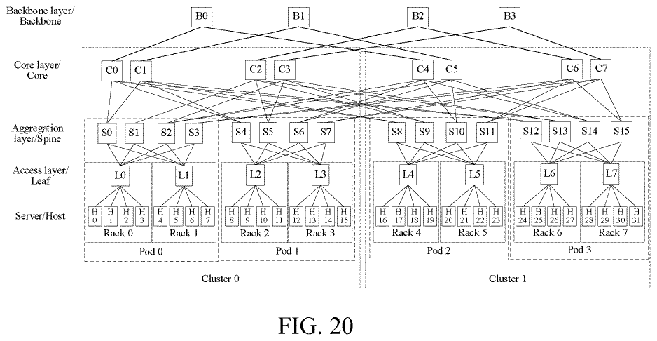

Further, for topological clustering, affinity sensing processing is performed. The topology sorting engine first queries the topology database for the topology information of each server in the operation server list. A form of the topology information is similar to {HostId: ClusterId, PodId, RackId}. The topology database may be queried for the topology information by using a server IP, a fixed asset number, or the like. As shown in FIG. 20, the server nodes may be divided based on a cluster, a pod, and a rack. Topology information of a server node H16 may be represented as {H16: 1, 2, 4}.

After topology information of all servers is found, the topology sorting engine performs hierarchical clustering on the servers, and specific operations are as follows:
(a) All the servers are clustered based on ClusterId. To be specific, servers having the same ClusterId are clustered together (arranged at neighboring locations). An actual operation is traversing all servers; checking ClusterId of the servers; and adding a server to a class if the cluster has the class of ClusterId; otherwise, creating a class of ClusterId, and adding the server to the class.
(b) In each cluster having the same ClusterId, clustering is performed based on PodId. To be specific, servers having the same PodId are clustered together (arranged at neighboring locations). An actual operation is traversing all servers in each cluster class, checking PodId of the servers; and adding a server to a class if the cluster has the class of PodId; otherwise, creating a class of PodId, and adding the server to the class.
(c) In each cluster having the same ClusterId and PodId, clustering is performed based on RackId. To be specific, servers having the same RackId are clustered together (arranged at neighboring locations). An actual operation is traversing all servers in each pod class; checking RackId of the servers; and adding a server to a class if the cluster has the class of RackId; otherwise, creating a class of RackId, and adding the server to the class. So far, all servers participating in the collective communication operation have been clustered. That is, affinity sensing has been achieved.

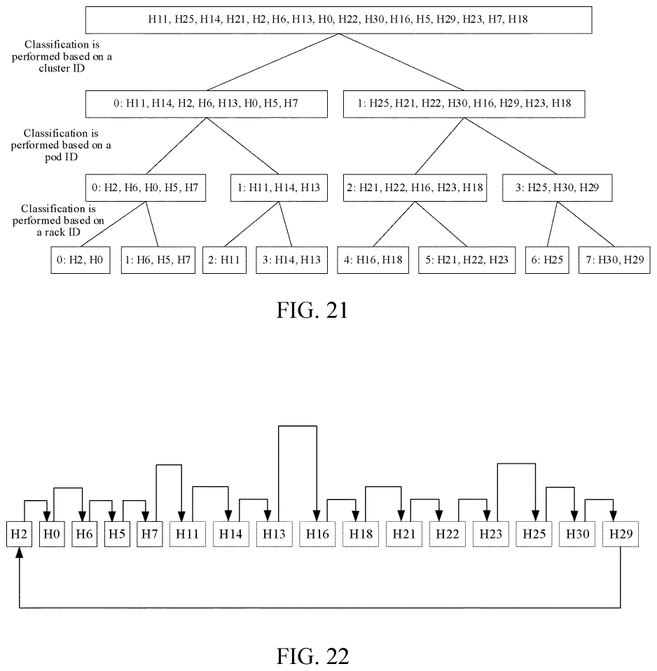

As shown in FIG. 20, a list of servers that are in the servers and that participate in a collective communication operation may be: [H11, H25, H14, H21, H2, H6, H13, H0, H22, H30, H16, H5, H29, H23, H7, H18]. Then, FIG. 21 shows a clustering result for a list of servers that participate in a collective communication operation in FIG. 20. Specifically, after clustering is performed based on ClusterId, two cluster classes, namely, {0: [H11, H14, H2, H6, H13, H0, H5, H7]} and {1: [H25, H21, H22, H30, H16, H29, H23, H18]}, are obtained. After clustering is performed based on PodId, four pod classes, namely, {0: [H2, H6, H0, H5, H7]}, {1, [H11, H14, H13]}, {2: [H21, H22, H16, H23, H18]}, and {3: [H25, H30, H29]}, may be obtained. After clustering is performed based on RackId, eight rack classes, namely, {0: [H2, H0]}, {1: [H6, H5, H7]}, {2: [h11]}, {3: [h14, H13]}, {4: [h16, H18]}, {5: [h21, H22, H23]}, {6: [H25]}, and {7: [H30, H29]}, may be obtained.

Further, orchestration optimization processing is performed on a node. After a clustering result is obtained, topology optimization orchestration needs to be performed based on the result. A specific method is performing depth-first search/traversal on the clustering result. To be specific, in a clustering tree, a pod below is searched for cluster by cluster, a rack below is searched for pod by pod, and the found nodes are sequentially placed in an optimization list L.

For example, for the clustering tree shown in FIG. 21:
(a) A cluster 0 is first searched for. Because no leaf node is reached, a pod 0 is further searched for. Because no leaf node is reached, a rack 0 is further searched for. The rack 0 is already a leaf node, and a server (H2, H0) thereof is placed in the optimization list L. In this case, L=[H2, H0].
(b) Another rack also below the pod 0 is searched for. The Rack 1 is found. A server thereof is placed in an optimization list L. In this case, L=[H2, H0, H6, H5, H7].
(c) In this case, searching of a leaf of the pod 0 has been completed. Another pod, namely, a pod 1, also below the cluster 0 is searched for. A rack 2 below the pod 1 is searched for. A server of the rack 2 is placed in L, where L=[H2, H0, H6, H5, H7, H11].
(d) Then, a rack 3 also below the pod 1 is searched for. A server of the rack 3 is placed in L, where L=[H2, H0, H6, H5, H7, H11, H14, H13].
(e) So far, searching of the cluster 0 has been completed. Then, a cluster 1 is searched for. The rest can be deduced by analogy, until searching of all racks is completed. A finally obtained optimization list is L=[H2, H0, H6, H5, H7, H11, H14, H13, H16, H18, H21, H22, H23, H25, H30, H29].

In the foregoing process, a searching order is not unique. For example, alternatively, the cluster 1 may be searched for first, and then the cluster 0 is searched for. For another example, in the pod 0, the rack 1 may be first searched for, and then the rack 0 is searched for. In addition, an sequence of servers in a rack is not limited. For example, in the rack 0, whether H0 or H2 is orchestrated first is the same, and a final logical effect is equivalent.

When the orchestrated list is configured for the Ring Allreduce operation, a formed traffic topology is shown in FIG. 22. Different heights of connection lines represent switch levels that the group of traffic crosses. For example, H13->H16 and H29->H2 both cross switches at a backbone layer, and H7->H11 and H23->H25 both cross switches at the core layer. It can be learned that traffic obtained through optimization orchestration has minimized a number of flows crossing switches at the aggregation layer, the core layer, and the backbone layer. In this way, a probability of congestion between the traffic and with other traffic can be minimized, thereby improving training throughput. The topology on which optimization orchestration is performed in embodiments may alternatively be applied to other implementations of Allreduce, including implementations such as Tree-Allreduce and Halving-Doubling.

In addition, in the collective communication processing method provided in embodiments, a search starting point may further be changed. In embodiments, a search starts from the zeroth rack of the zeroth pod of the zeroth cluster. In a variation example, a search may alternatively start from the fourth rack of the second pod of the first cluster. Final topology rings on which orchestration optimization is performed are actually the same, but are rotated once. To be specific, starting points of the server nodes are different. An order of nodes in the same rack may also be changed. In embodiments, a plurality of nodes in the same rack are arranged based on an order of the nodes in the original operation node list, and actually may be randomly arranged again.

According to the collective communication processing method provided in embodiments, traffic scheduling of the collective operation in language large model training (AI HPC) is optimized, and includes traffic scheduling of the most widely used Allreduce operation. In embodiments, a centralized topological sorting technology and a request-answer-based architecture are used, so that optimization orchestration is performed on a server list provided by a cloud HPC service manufacturer for a tenant, thereby improving affinity of the collective operation, and optimizing traffic scheduling and throughput performance of the collective communication. In embodiments, congestion of HPC traffic in a network may be eliminated in a single-tenant scenario. Network congestion can also be minimized in a multi-tenant scenario, thereby maximizing throughput and efficiency of the HPC cluster, and significantly improving smoothness and stability of the network. Compared with a non-optimized scenario, embodiments may provide high throughput improvement of 70%.

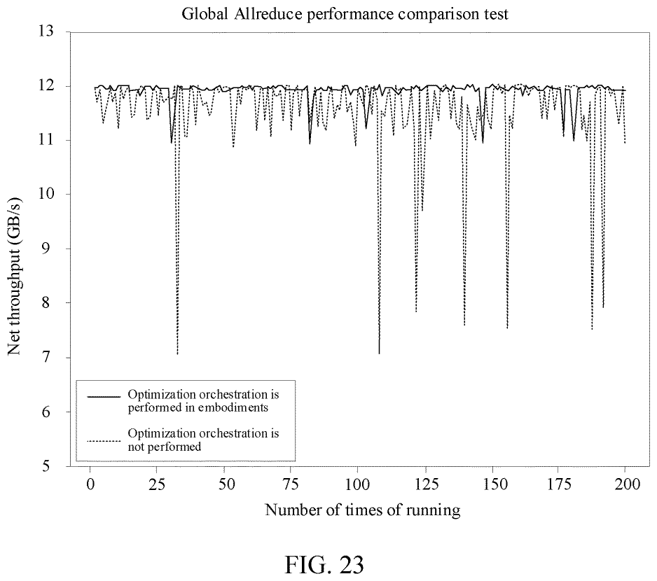

According to the collective communication processing method provided in embodiments, a delay of a collective communication operation can be minimized. Particularly, in the Ring Allreduce operation, optimized topology orchestration can reduce a communication delay by at least 50% compared with non-optimized orchestration. The collective communication processing method provided in embodiments can further minimize network bandwidth contention (network congestion), improve network smoothness, remove a bottleneck of a traffic loop of collective communication, and maximize throughput of a collective operation. Specifically, if there is only one tenant in a network, congestion may be completely eliminated in embodiments, so that network throughput reaches an ideal value. As shown in FIG. 23, in a 100 Gb network single-tenant scenario, 10 servers distributed on two racks are used to perform the Ring Allreduce operation. After the two solutions are each run on the 100 Gb network 200 times, the topology obtained through optimization orchestration may enable system throughput to be full, and net throughput (Busbw) reaches approximately 12 GB. Throughput reached by a traffic topology on which optimization orchestration is not performed is usually only approximately 7 GB to 8 GB. If there are a plurality of tenants, traffic on which optimization orchestration is not performed may loss more throughput due to network congestion.

Although the steps in the flowcharts in embodiments as described above are shown in sequence as indicated by the arrows, these steps are not necessarily performed in sequence in the order indicated by the arrows. Unless otherwise explicitly specified in the specification, an execution order of the steps is not strictly limited, and the steps may be performed in other orders. Moreover, at least some of the steps in the flowcharts in embodiments as described above may include a plurality of steps or a plurality of stages. These steps or stages are not necessarily performed and completed at the same moment, but may be performed at different moments. These steps or stages are not necessarily performed in sequence, but may be performed in turn or in alternation with other steps or at least some of the steps or stages in other steps.

Based on the same inventive concept, embodiments of this application further provide a collective communication processing apparatus configured to implement the foregoing collective communication processing methods. An implementation solution to the problem provided by the apparatus is similar to an implementation solution recorded in the foregoing methods. Therefore, for specific limitations in one or more collective communication processing apparatus embodiments provided below, refer to the foregoing limitations on the collective communication processing methods. Details are not described herein again.

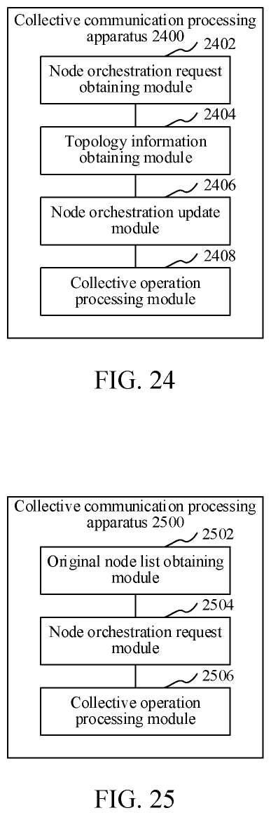

In one embodiment, as shown in FIG. 24, a collective communication processing apparatus 2400 is provided, and includes: a node orchestration request obtaining module 2402, a topology information obtaining module 2404, a node orchestration update module 2406, and a collective operation processing module 2408.

The node orchestration request obtaining module 2402 is configured to obtain a node orchestration request for a target collective operation in collective communication, the node orchestration request carrying an original node list, and the original node list including server nodes selected to perform the target collective operation;
the topology information obtaining module 2404 is configured to obtain topology information of the server nodes, the topology information being configured to describe switching nodes connected to the server nodes at various levels in a node communication network, and the server nodes communicating with each other based on the switching nodes connected at the levels in the node communication network;
the node orchestration update module 2406 is configured to perform an orchestration update on an sequence of the server nodes level by level based on the topology information and the levels in the node communication network, to obtain an orchestration node list; and
the collective operation processing module 2408 is configured to perform collective communication for the target collective operation by using the server nodes based on an sequence of the server nodes in the orchestration node list.

In an embodiment, the node orchestration update module 2406 is further configured to: perform hierarchical clustering on the server nodes level by level based on the topology information and the levels in the node communication network, to obtain topological clustering results of the server nodes; and perform a node search level by level based on the topological clustering results and the levels in the node communication network, to obtain the orchestration node list, the sequence of the server nodes in the orchestration node list being the same as a hierarchical order of the node search.

In an embodiment, the node orchestration update module 2406 is further configured to perform hierarchical clustering on the server nodes level by level based on the topology information and a descending level dimension in the node communication network, to obtain the topological clustering results of the server nodes, where in the node communication network, a high-level switching node is configured to support cross-node communication between server nodes connected to low-level switching nodes.

In an embodiment, the levels in the node communication network include a core layer, an aggregation layer, and an access layer in descending order; and the node orchestration update module 2406 is further configured to: cluster the server nodes based on the topology information and a level dimension of the core layer, to obtain core layer clustering results of the server nodes; cluster the server nodes based on the core layer clustering results and a level dimension of the aggregation layer, to obtain aggregation layer clustering results of the server nodes; and cluster the server nodes based on the aggregation layer clustering results and a level dimension of the access layer, to obtain the topological clustering results of the server nodes.

In an embodiment, the node orchestration update module 2406 is further configured to perform the node search on the server nodes level by level based on the topological clustering results and a descending level dimension in the node communication network, to obtain the orchestration node list, where in the node communication network, a high-level switching node is configured to support cross-node communication between server nodes connected to low-level switching nodes.

In an embodiment, the levels in the node communication network include a core layer, an aggregation layer, and an access layer in descending order; and that the node orchestration update module 2406 is further configured to perform the node search on the server nodes level by level based on the topological clustering results and a descending level dimension in the node communication network, to obtain the orchestration node list includes: performing a search based on the topological clustering results and a level dimension of the core layer, to obtain core layer search results; performing a search based on the core layer search results and a level dimension of the aggregation layer, to obtain aggregation layer search results; performing a search based on the aggregation layer search results and a level dimension of the access layer, to obtain access layer search results; and obtaining the orchestration node list based on the core layer search results, the aggregation layer search results, and the access layer search results.

In an embodiment, the node orchestration request obtaining module 2402 is further configured to: determine a collective communication library in the collective communication; and obtain the node orchestration request for the target collective operation in the collective communication based on a communication interface to the collective communication library.

In an embodiment, the topology information obtaining module 2404 is further configured to: determine a topology database associated with the node communication network; and query the topology database for the topology information of the server nodes based on the original node list.

In an embodiment, the node orchestration request obtaining module 2402 is further configured to obtain the node orchestration request from a target server node, the target server node being determined in the server nodes selected to perform the target collective operation in the collective communication; and the collective operation processing module 2408 is further configured to transmit the orchestration node list to the target server node, the orchestration node list indicating the target server node to perform collective communication based on the target collective operation by using the server nodes based on the sequence of the server nodes in the orchestration node list.

In an embodiment, a trigger determining module is further included, and is configured to perform, when the server nodes for the target collective operation meet an orchestration update trigger condition, the operation of the obtaining a node orchestration request for a target collective operation in collective communication.

In one embodiment, as shown in FIG. 25, a collective communication processing apparatus 2500 is provided, and includes: an original node list obtaining module 2502, a node orchestration request module 2504, and a collective operation processing module 2506.

The original node list obtaining module 2502 is configured to determine an original node list when triggering a target collective operation in collective communication, the original node list including server nodes selected to perform the target collective operation;
the node orchestration request module 2504 is configured to transmit, to a server, a node orchestration request generated based on the original node list, the node orchestration request indicating the server to return an orchestration node list, and the orchestration node list being obtained by performing an orchestration update on an sequence of the server nodes in the original node list level by level based on topology information of the server nodes and levels in a node communication network; and
the collective operation processing module 2506 is configured to receive the orchestration node list, and perform collective communication based on the target collective operation by using the server nodes based on an sequence of the server nodes in the orchestration node list.

All or some of the modules in the collective communication processing apparatuses may be implemented by software, hardware, and a combination thereof. The modules may be built in or stand alone from a processor in a computer device in a form of hardware, or may be stored in a memory in a computer device in a form of software, so that a processor invokes and executes operations corresponding to the modules.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

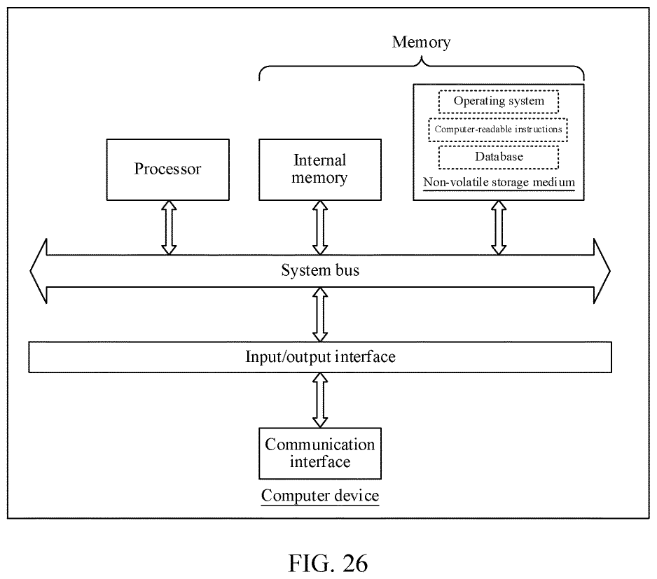

In one embodiment, a computer device is provided. The computer device may be a server or a terminal, and a diagram of an internal structure of the computer device may be shown in FIG. 26. The computer device includes a processor, a memory, an input/output (briefly referred to as I/O) interface, and a communication interface. The processor, the memory, and the input/output interface are connected to each other through a system bus, and the communication interface is connected to the system bus through the input/output interface. The processor of the computer device is configured to provide computation and control abilities. The memory of the computer device includes a non-volatile storage medium and an internal memory. The non-volatile storage medium stores an operating system, computer-readable instructions, and a database. The internal memory provides a running environment for the operating system and the computer-readable instructions in the non-volatile storage medium. The database of the computer device is configured to store collective communication processing data. The input/output interface of the computer device is configured to exchange information between the processor and an external device. The communication interface of the computer device is configured to connect to and communicate with an external terminal through a network. A collective communication processing method is implemented when the computer-readable instructions are executed by the processor. A person skilled in the art may understand that, the structure shown in FIG. 26 is merely a block diagram of a part of a structure related to a solution in this application and does not limit the computer device to which the solution in this application is applied. Specifically, the computer device may include more or fewer parts than those shown in the drawings, include a combination of some parts, or have different part layouts.

In an embodiment, a computer device is further provided, and includes a memory and a processor. The memory stores computer-readable instructions. The steps in the foregoing method embodiments are implemented when the processor executes the computer-readable instructions.

In an embodiment, a computer-readable storage medium is provided, and stores computer-readable instructions. The operations in the foregoing method embodiments are implemented when the computer-readable instructions are executed by a processor.

In an embodiment, a computer program product is provided, and includes computer-readable instructions. The operations in the foregoing method embodiments are implemented when the computer-readable instructions are executed by a processor.

User information (including, but not limited to, user equipment information, user personal information, and the like) and data (including, but not limited to, data for analysis, stored data, displayed data, and the like) in this application are all information and data authorized by a user or fully authorized by all parties, and collection, use, and processing of relevant data need to comply with relevant stipulations.

A person of ordinary skill in the art may understand that all or some of the procedures of the methods in the foregoing embodiments may be implemented by computer-readable instructions instructing relevant hardware. The computer-readable instructions may be stored in a non-volatile computer-readable storage medium. When the computer-readable instructions are executed, the procedures of the foregoing method embodiments may be included. Any reference to a memory, a database, or other media used in embodiments provided in this application may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache, or the like. For the purpose of illustration but not limitation, the RAM may be in many forms, for example, a static random access memory (SRAM), a dynamic random access memory (DRAM), or the like. The databases in embodiments provided in this application may include at least one of a relational database and a non-relational database. The non-relational database may include a blockchain-based distributed database and the like, but is not limited thereto. The processor in embodiments provided in this application may be a general-purpose processor, a central processing unit, a graphics processor, a digital signal processor, a programmable logic device, a data processing logic device based on quantum computing, or the like, but is not limited thereto.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by the specification provided that no conflict exists. The foregoing embodiments show only several implementations of this application and are described in detail, which, however, are not to be construed as a limitation to the patent scope of this application. For a person of ordinary skill in the art, several transformations and improvements can be made without departing from the idea of this application. These transformations and improvements belong to the protection scope of this application. Therefore, the protection scope of this application shall be subject to the appended claims.

What is claimed is:

1. A collective communication processing method, performed by a server, and comprising:
obtaining a node orchestration request for a target collective operation in collective communication, the node orchestration request carrying an original node list, and the original node list comprising server nodes selected to perform the target collective operation;
obtaining topology information of the server nodes, the topology information describing switching nodes connected to the server nodes at various levels in a node communication network, and the server nodes communicating with each other based on the switching nodes connected at the levels in the node communication network;
performing an orchestration update on a sequence of the server nodes based on the topology information and levels in the node communication network, to obtain an orchestration node list; and
performing collective communication for the target collective operation using the server nodes based on the sequence of the server nodes in the orchestration node list.

2. The method according to claim 1, wherein the performing the orchestration update comprises:
performing hierarchical clustering on the server nodes based on the topology information and the levels in the node communication network, to obtain topological clustering results of the server nodes; and
performing a node search based on the topological clustering results and the levels in the node communication network, to obtain the orchestration node list, the sequence of the server nodes in the orchestration node list being the same as a hierarchical order of the node search.

3. The method according to claim 2, wherein the performing hierarchical clustering on the server nodes comprises:
performing hierarchical clustering on the server nodes based on the topology information and a descending level dimension in the node communication network, to obtain the topological clustering results of the server nodes, wherein
in the node communication network, a high-level switching node is configured to support cross-node communication between server nodes connected to low-level switching nodes.

4. The method according to claim 3, wherein the levels in the node communication network comprise a core layer, an aggregation layer, and an access layer in descending order; and
the performing hierarchical clustering on the server nodes based on the topology information and a descending level dimension in the node communication network, to obtain the topological clustering results of the server nodes comprises:
clustering the server nodes based on the topology information and a level dimension of the core layer, to obtain core layer clustering results of the server nodes;
clustering the server nodes based on the core layer clustering results and a level dimension of the aggregation layer, to obtain aggregation layer clustering results of the server nodes; and
clustering the server nodes based on the aggregation layer clustering results and a level dimension of the access layer, to obtain the topological clustering results of the server nodes.

5. The method according to claim 2, wherein the performing a node search based on the topological clustering results and the levels in the node communication network, to obtain the orchestration node list comprises:
performing the node search on the server nodes based on the topological clustering results and a descending level dimension in the node communication network, to obtain the orchestration node list, wherein in the node communication network, a high-level switching node is configured to support cross-node communication between server nodes connected to low-level switching nodes.

6. The method according to claim 5, wherein the levels in the node communication network comprise a core layer, an aggregation layer, and an access layer in descending order; and
the performing the node search on the server nodes based on the topological clustering results and a descending level dimension in the node communication network, to obtain the orchestration node list comprises:
performing a search based on the topological clustering results and a level dimension of the core layer, to obtain core layer search results;
performing a search based on the core layer search results and a level dimension of the aggregation layer, to obtain aggregation layer search results;
performing a search based on the aggregation layer search results and a level dimension of the access layer, to obtain access layer search results; and
obtaining the orchestration node list based on the core layer search results, the aggregation layer search results, and the access layer search results.

7. The method according to claim 1, wherein the obtaining a node orchestration request for a target collective operation in collective communication comprises:
determining a collective communication library in the collective communication; and
obtaining the node orchestration request for the target collective operation in the collective communication based on a communication interface to the collective communication library.

8. The method according to claim 1, wherein the obtaining topology information of the server node comprises:
determining a topology database associated with the node communication network; and
querying the topology database for the topology information of the server nodes based on the original node list.

9. The method according to claim 1, wherein the obtaining a node orchestration request for a target collective operation in collective communication comprises:
obtaining the node orchestration request from a target server node, the target server node being determined in the server nodes selected to perform the target collective operation in the collective communication; and
the performing collective communication for the target collective operation using the server nodes based on an sequence of the server nodes in the orchestration node list comprises:
transmitting the orchestration node list to the target server node, the orchestration node list indicating the target server node to perform collective communication based on the target collective operation using the server nodes based on the sequence of the server nodes in the orchestration node list.

10. The method according to claim 1, wherein the method further comprises:
performing, when the server nodes for the target collective operation meet an orchestration update trigger condition, the operation of the obtaining a node orchestration request for a target collective operation in collective communication.

11. A computer device, comprising a memory and a processor, the memory having computer-readable instructions stored therein, and the operations of a collective communication processing method, performed by a server, and comprising:
obtaining a node orchestration request for a target collective operation in collective communication, the node orchestration request carrying an original node list, and the original node list comprising server nodes selected to perform the target collective operation;
obtaining topology information of the server nodes, the topology information describing switching nodes connected to the server nodes at various levels in a node communication network, and the server nodes communicating with each other based on the switching nodes connected at the levels in the node communication network;
performing an orchestration update on a sequence of the server nodes based on the topology information and levels in the node communication network, to obtain an orchestration node list; and
performing collective communication for the target collective operation using the server nodes based on the sequence of the server nodes in the orchestration node list.

12. The computer device according to claim 11, wherein the performing the orchestration update comprises:
performing hierarchical clustering on the server nodes based on the topology information and the levels in the node communication network, to obtain topological clustering results of the server nodes; and
performing a node search based on the topological clustering results and the levels in the node communication network, to obtain the orchestration node list, the sequence of the server nodes in the orchestration node list being the same as a hierarchical order of the node search.

13. The computer device according to claim 12, wherein the performing hierarchical clustering on the server nodes comprises:
performing hierarchical clustering on the server nodes based on the topology information and a descending level dimension in the node communication network, to obtain the topological clustering results of the server nodes, wherein
in the node communication network, a high-level switching node is configured to support cross-node communication between server nodes connected to low-level switching nodes.

14. The computer device according to claim 13, wherein the levels in the node communication network comprise a core layer, an aggregation layer, and an access layer in descending order; and
the performing hierarchical clustering on the server nodes based on the topology information and a descending level dimension in the node communication network, to obtain the topological clustering results of the server nodes comprises:
clustering the server nodes based on the topology information and a level dimension of the core layer, to obtain core layer clustering results of the server nodes;
clustering the server nodes based on the core layer clustering results and a level dimension of the aggregation layer, to obtain aggregation layer clustering results of the server nodes; and
clustering the server nodes based on the aggregation layer clustering results and a level dimension of the access layer, to obtain the topological clustering results of the server nodes.

15. The computer device according to claim 12, wherein the performing a node search based on the topological clustering results and the levels in the node communication network, to obtain the orchestration node list comprises:
performing the node search on the server nodes based on the topological clustering results and a descending level dimension in the node communication network, to obtain the orchestration node list, wherein in the node communication network, a high-level switching node is configured to support cross-node communication between server nodes connected to low-level switching nodes.

16. The computer device according to claim 15, wherein the levels in the node communication network comprise a core layer, an aggregation layer, and an access layer in descending order; and
the performing the node search on the server nodes based on the topological clustering results and a descending level dimension in the node communication network, to obtain the orchestration node list comprises:
performing a search based on the topological clustering results and a level dimension of the core layer, to obtain core layer search results;
performing a search based on the core layer search results and a level dimension of the aggregation layer, to obtain aggregation layer search results;
performing a search based on the aggregation layer search results and a level dimension of the access layer, to obtain access layer search results; and
obtaining the orchestration node list based on the core layer search results, the aggregation layer search results, and the access layer search results.

17. The computer device according to claim 11, wherein the obtaining a node orchestration request for a target collective operation in collective communication comprises:
determining a collective communication library in the collective communication; and
obtaining the node orchestration request for the target collective operation in the collective communication based on a communication interface to the collective communication library.

18. The computer device according to claim 11, wherein the obtaining topology information of the server node comprises:
determining a topology database associated with the node communication network; and
querying the topology database for the topology information of the server nodes based on the original node list.

19. A non-transitory computer-readable storage medium, having computer-readable instructions stored therein, the operations of a collective communication processing method, performed by a server, and comprising:
obtaining a node orchestration request for a target collective operation in collective communication, the node orchestration request carrying an original node list, and the original node list comprising server nodes selected to perform the target collective operation;
obtaining topology information of the server nodes, the topology information describing switching nodes connected to the server nodes at various levels in a node communication network, and the server nodes communicating with each other based on the switching nodes connected at the levels in the node communication network;
performing an orchestration update on a sequence of the server nodes based on the topology information and levels in the node communication network, to obtain an orchestration node list; and
performing collective communication for the target collective operation using the server nodes based on the sequence of the server nodes in the orchestration node list.

20. The computer-readable storage medium according to claim 19, wherein the performing the orchestration update comprises:
performing hierarchical clustering on the server nodes based on the topology information and the levels in the node communication network, to obtain topological clustering results of the server nodes; and
performing a node search based on the topological clustering results and the levels in the node communication network, to obtain the orchestration node list, the sequence of the server nodes in the orchestration node list being the same as a hierarchical order of the node search.
